(19) United States
(12) Patent Application Publication
(10) Pub. No.: US 2024/0114460 A1
(43) Pub. Date: Apr. 4, 2024

(54) METHOD AND APPARATUS FOR ENERGY SAVINGS OF A WIRELESS COMMUNICATION SYSTEM

(71) Applicant: Samsung Electronics Co., Ltd., Gyeonggi-do (KR)

(72) Inventors: Junyung YI, Gyeonggi-do (KR); Youngbum KIM, Gyeonggi-do (KR); Hyewon YANG, Gyeonggi-do (KR); Youngrok JANG, Gyeonggi-do (KR)

(21) Appl. No.: 18/472,476

(22) Filed: Sep. 22, 2023

(30) Foreign Application Priority Data
Sep. 23, 2022 (KR) 10-2022-0120929

(51) Int. Cl. H04W 52/02; H04W 76/28

(52) U.S. Cl. CPC H04W 52/0248; H04W 76/28

(57) ABSTRACT

The disclosure relates to a communication method for merging, with an IoT technology, a 5G or 6G communication system for supporting a data transmission rate higher than that of a 4G system, and a system therefor. The disclosure provides methods for saving an energy of a BS. A method performed by a terminal in a wireless communication system includes receiving, from a BS, information for configuring at least one configuration associated with network energy saving, in a first slot, identifying a delay time for applying the network energy saving, and applying the network energy saving at a second slot that is determined based on the first slot and the delay time.

### CROSS REFERENCE TO RELATED APPLICATION

This application is based on and claims priority under 35 U.S.C. § 119 to Korean Patent Application No. 10-2022-0120929, which was filed in Korean Intellectual Property Office on Sep. 23, 2022, the entire content of which is incorporated herein by reference.

### BACKGROUND

### 1. Field

The disclosure relates generally to a method and apparatus for energy savings of a wireless communication system.

### 2. Description of Related Art

5th generation (5G) mobile communication technologies define broad frequency bands such that high transmission rates and new services are possible, and can be implemented in “sub 6 GHz” bands such as 3.5 GHz, and also in “above 6 GHz” bands, which may be referred to as mmWave, including 28 GHz and 39 GHz. In addition, it has been considered to implement 6th generation (6G) mobile communication technologies (e.g., referred to as beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There is also ongoing standardization in system architecture/service regarding a 5G baseline architecture (e.g., service based architecture or service based interface) for combining network functions virtualization (NFV) and software-defined networking (SDN) technologies, and Mobile Edge Computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. Following the commercialization of 5G communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as AR glasses, VR headsets, and hologram devices. In order to provide various services by connecting hundreds of billions of devices and things in the 6G era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (e.g., 95 GHz to 3 THz bands). It is expected that, due to severer path loss and atmospheric absorption in the terahertz bands than those in mmWave bands introduced in 5G, technologies capable of securing the signal transmission distance (i.e., coverage) will become more crucial. It is necessary to develop, as major technologies for securing the coverage, radio frequency (RF) elements, antennas, novel waveforms having a better coverage than orthogonal frequency division multiplexing (OFDM), beamforming and massive MIMO, FD-MIMO, array antennas, and multiantenna transmission technologies such as large-scale antennas. In addition, there has been ongoing discussion on new technologies for improving the coverage of terahertz-band signals, such as metamaterial-based lenses and antennas, OAM, and RIS.

Moreover, in order to improve the spectral efficiency and the overall network performances, the following technologies have been developed for 6G communication systems: a full-duplex technology for enabling an uplink (UL) transmission and a downlink (DL) transmission to simultaneously use the same frequency resource at the same time; a network technology for utilizing satellites, high-altitude platform stations (HAPS), etc., in an integrated manner; an improved network structure for supporting mobile base stations (BSs) and the like and enabling network operation optimization and automation and the like; a dynamic spectrum sharing technology via collision avoidance based on a prediction of spectrum usage; an use of AI in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as MEC, clouds, etc.) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive XR, high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

With the recent development of environmentally conscious 5G/6G communication systems, a need for methods to reduce energy consumption of a BS is emerging.

### SUMMARY

The disclosure is made to address at least the above-mentioned problems and/or disadvantages and to provide at least the advantages described below.

An aspect of the disclosure is to provide a method for determining a processing time and application timing for applying an energy saving method.

Another aspect of the disclosure is to provide a method for reducing energy consumption of a BS in a wireless communication system.

Another aspect of the disclosure is to provide a UE that, for energy saving of a BS, may determine the processing time and application time at which the configurations for energy saving of the BS may be applied, according to a reference signal (RS) (e.g., synchronization signal block (SSB) or channel state information RS (CSI-RS)) transmission configuration change, system bandwidth/BWP switching and antenna port (i.e., transceiver unit (TxRU) adaptation) configuration information change, and discontinuous reception (DRX) configuration of UEs for discontinuous transmission (DTX) of the BS through higher layer signaling and dynamic signaling.

In accordance with an aspect of the disclosure, a method performed by a terminal in a wireless communication system includes receiving, from a BS, information for configuring at least one configuration associated with network energy saving, in a first slot, identifying a delay time for applying the network energy saving, and applying the network energy saving at a second slot that is determined based on the first slot and the delay time.

In accordance with another aspect of the disclosure, a terminal in a wireless communication system includes a transceiver, and a processor configured to receive, via the transceiver, from a BS, in a first slot, information for configuring at least one configuration associated with network energy saving, identify a delay time for applying the network energy saving, and apply the network energy saving at a second slot that is determined based on the first slot and the delay time.

In accordance with another aspect of the disclosure, a method performed by a BS in a wireless communication system includes determining to apply network energy saving, and transmitting, to a terminal, in a first slot, information for configuring at least one configuration associated with the network energy saving. The network energy saving is applied at a second slot that is determined based on the first slot and a delay time associated with the network energy saving.

In accordance with another aspect of the disclosure, a BS in a wireless communication system includes a transceiver, and a processor configured to determine to apply network energy saving, and transmit, via the transceiver, to a terminal, in a first slot, information for configuring at least one configuration associated with the network energy saving. The network energy saving is applied at a second slot that is determined based on the first slot and a delay time associated with the network energy saving.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain that is a radio resource region in a wireless communication system, according to an embodiment;

FIG. 2 illustrates a slot structure in a wireless communication system, according to an embodiment;

FIG. 3 illustrates a time region mapping structure of a synchronization signal (SS) and an example of beam-sweeping operation in a wireless communication system, according to an embodiment;

FIG. 4 illustrates an SSB for use in a wireless communication system according to an embodiment;

FIG. 5 illustrates an SSB in a wireless communication system being transmitted in a frequency band less than 6 GHz, according to an embodiment;

FIG. 6 illustrates an SSB in a wireless communication system being transmitted in a frequency band of 6 GHz or higher, according to an embodiment;

FIG. 7 illustrates an SSB according to a SCS is transmitted within 5 ms in a wireless communication system, according to an embodiment of the disclosure.

FIG. 8 illustrates a demodulation RS (DMRS) pattern (e.g., type1 and type2) used for communication between a BS and a terminal in a wireless communication system, according to an embodiment;

FIG. 9 illustrates channel estimation using a DMRS received through one PUSCH in a time band in a wireless communication system, according to an embodiment;

FIG. 10 illustrates a method for reconfiguring SSB transmission through dynamic signaling in a wireless communication system, according to an embodiment;

FIG. 11 illustrates a method for reconfiguring a BWP and/or BW through dynamic signaling in a wireless communication system, according to an embodiment;

FIG. 12 illustrates a method for reconfiguring DRX through dynamic signaling in a wireless communication system, according to an embodiment;

FIG. 13 illustrates an antenna adaptation method of a BS for energy saving of a wireless communication system, according to an embodiment;

FIG. 14A illustrates a timeline according to BWP switching in a wireless communication system, according to an embodiment;

FIG. 14B illustrates an example of T_{BWPswitchDelay} value according to SCS, according to an embodiment;

FIG. 15 illustrates a timeline for beam switching in a wireless communication system, according to an embodiment;

FIG. 16 illustrates a timeline for applying a method for saving an energy of a BS in a wireless communication system, according to an embodiment;

FIG. 17 is a flowchart illustrating an energy saving method performed by a UE in a wireless communication system, according to an embodiment;

FIG. 18 illustrates a flowchart illustrating a BS energy saving method in a wireless communication system, according to an embodiment;

FIG. 19 illustrates a UE, according to an embodiment; and

FIG. 20 illustrates a BS, according to an embodiment.

### DETAILED DESCRIPTION

Hereinafter, various embodiments of the disclosure are described with reference to the accompanying drawings.

In describing embodiments, descriptions related to technical contents which are well-known in the art to which the disclosure pertains, and are not directly associated with the disclosure, will be omitted. Such an omission of unnecessary descriptions is intended to prevent obscuring of the main idea of the disclosure and more clearly convey the main idea.

In the drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose and inform those skilled in the art of the scope of the disclosure, and the appended claims. Throughout the specification, the same or like reference numerals designate the same or like elements.

Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a BS is an entity that allocates resources to terminals, and may be at least one of a gNode B, an eNode B, a Node B, a wireless access unit, a BS controller, and a node on a network. A terminal may include a UE, a mobile station (MS), a cellular phone, a smartphone, a computer, or a multimedia system capable of performing communication functions.

In the disclosure, a “downlink (DL)” refers to a radio link via which a BS transmits a signal to a terminal, and an “uplink (UL)” refers to a radio link via which a terminal transmits a signal to a BS.

Further, although the following description may be directed to a long term evolution (LTE) or LTE-advanced (LTE-A) system by way of example, embodiments of the disclosure may also be applied to other communication systems having similar technical backgrounds or channel types to the embodiments of the disclosure. Examples of other communication systems may include 5G NR developed beyond LTE-A, and in the following description, “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create a means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed concurrently or the blocks may sometimes be executed in the reverse order, depending upon the functionality involved.

As used herein, a “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, the “unit” may include, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may either be combined into a smaller number of elements, or a “unit”, or divided into a larger number of elements, or a “unit”. Moreover, the elements and “units” may be implemented to reproduce one or more central processing units (CPUs) within a device or a security multimedia card. Further, the term “unit” in the embodiments may include one or more processors.

A wireless communication system has developed into a broadband wireless communication system that provides a high-speed and high-quality packet data service according to communication standards such as high-speed packet access (HSPA) of third generation partnership project (3GPP), LTE or evolved universal terrestrial radio access (E-UTRA), (LTE-A, LTE-Pro, high rate packet data (HRPD) of 3GPP2, ultra mobile broadband (UMB), and 802.17e of the Institute of Electrical and Electronics Engineers (IEEE) beyond the initially provided voice-based service.

An LTE system, which is a representative example of the broadband wireless communication system, employs an OFDM scheme for a DL, and employs a single carrier frequency division multiple access (SC-FDMA) scheme for a UL. The UL is a radio link through which a UE (or an MS) transmits data or a control signal to a BS (or an eNode B), and the DL is a radio link through which the BS transmits data or a control signal to the UE. In the multiple access schemes as described above, time-frequency resources for carrying data or control information may be allocated and operated in a manner to prevent overlapping of the resources, i.e., to establish the orthogonality, between users, so as to identify data or control information of each user.

A post-LTE communication system, i.e., a 5G communication system, should be able to freely reflect various requirements of a user and a service provider, and thus it is required to support a service which satisfies the various requirements. Services which are considered for the 5G communication system include eMBB, mMTC, and URLLC.

The eMBB aims to provide a data transmission rate which is improved so as to surpass the data transmission speed supported by conventional LTE, LTE-A, or LTE-Pro. For example, in the 5G communication system, the eMBB should provide a peak DL data rate of 20 gigabits per second (Gbps) and a peak UL data rate of 10 Gbps from the viewpoint of one BS. Further, the 5G communication system should provide not only the peak data rate but also an increased user-perceived data rate. In order to satisfy such requirements, improvement of various transmission/reception technologies, including a further improved MIMO transmission technology, is needed. Further, while the current LTE system uses transmission bandwidths from a bandwidth of 2 GHz to a maximum bandwidth of 20 megahertz (MHz) to transmit signals, the 5G communication system uses a frequency bandwidth wider than 20 MHz in frequency bands of 3 to 6 GHz or higher than or equal to 6 GHz, whereby the data transmission rate required by the 5G communication system can be satisfied.

In order to support an application service such as the IoT, mMTC is considered in the 5G communication system. The mMTC may be used to support access of multiple UEs within a cell, improve coverage of the UE, increase a battery lifetime, and reduce the costs of the UE in order to efficiently provide IoT technology. IoT technology is used in conjunction with various sensors and devices to provide communication, and thus should support a large number of UEs (e.g., 1,000,000 UEs/kilometer2 (km2)) within the cell. Since a UE supporting mMTC is highly likely to be located in a shaded area, such as a basement of a building, which a cell cannot cover due to service characteristics, the mMTC may require wider coverage than other services provided by the 5G communication system. The UE supporting the mMTC should also be produced at low cost and it is difficult to frequently exchange a battery thereof. Thus, a long battery lifetime, e.g., 10 to 15 years, may be required.

URLLC is a cellular-based wireless communication service used for a particular (mission-critical) purpose. For example, services used for remote control of robots or machinery, industrial automation, unmanned aerial vehicles, remote health care, and emergency alerts may be considered. Accordingly, communication provided by the URLLC should provide very low latency and very high reliability. Services supporting the URLLC should satisfy a radio access delay time (air interface latency) shorter than 0.5 milliseconds and have a requirement of a packet error rate equal to or smaller than 10−5. Accordingly, for services supporting the URLLC, the 5G system should provide a transmit time interval (TTI) smaller than that of other systems and also have a design requirement of allocating a wide array of resources in a frequency band in order to guarantee reliability of a communication link.

Three services of 5G, namely, eMBB, URLLC, and mMTC, may be multiplexed and transmitted in one system. In order to meet the different requirements of the respective services, different transmission/reception schemes and transmission/reception parameters may be used for the services. Of course, 5G is not limited to the above-described three services.

Hereinafter, a wireless communication system to which the disclosure is applied will be described with reference to a 5G system as an example for convenience of description, but embodiments of the disclosure are not limited thereto and may be applied in the same or similar manner even in 5G or higher systems or other communication systems to which the disclosure is applicable.

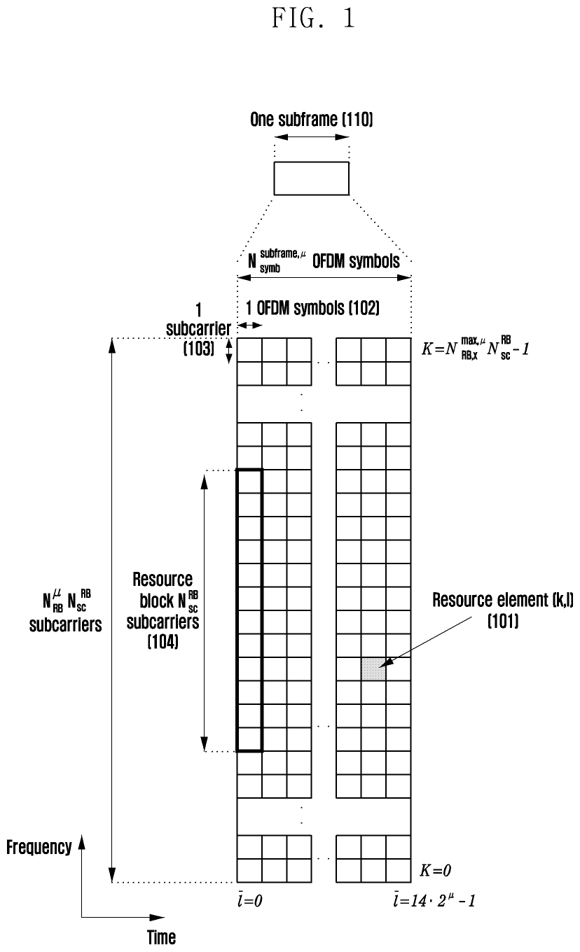

FIG. 1 illustrates a basic structure of a time-frequency domain that is a radio resource region in a wireless communication system, according to an embodiment.

Referring to FIG. 1, a horizontal axis indicates a time domain and a vertical axis indicates a frequency domain. A basic unit of resources in the time and frequency domain is a resource element (RE) 101 and may be defined as 1 OFDM symbol (or discrete Fourier transform spread OFDM (DFT-s-OFDM) symbol) 102 in the time axis and 1 subcarrier 103 in the frequency axis. In the frequency domain, N_{SC}^{RB} (e.g., 12) consecutive REs indicating the number of subcarriers per resource block (RB) may constitute one RB 104. Further in the time domain, N_{symb}^{subframe} consecutive OFDM symbols indicating the number of symbols per a subframe may constitute one subframe 110.

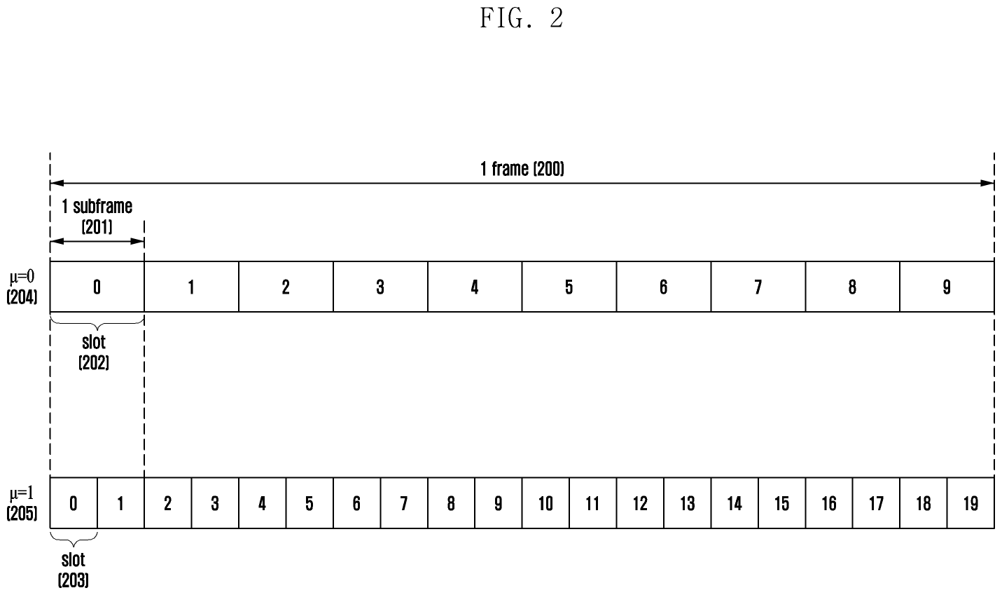

FIG. 2 illustrates a slot structure for use in a wireless communication system, according to an embodiment.

Referring to FIG. 2, the slot structure includes a frame 200, a subframe 201, and a slot 202 or 203. The frame 200 may be defined as 10 milliseconds (ms). The subframe 201 may be defined as 1 ms, and accordingly one frame 200 may include a total of 10 subframes 201. The slot 202 or 203 may be defined as 14 OFDM symbols (i.e., the number symbols N_{symb}^{slot} per slot=14). The subframe 201 may include one or a plurality of slots 202 and 203, and the number of slots 202 or 203 per subframe 201 may vary depending on a configuration value μ 204 or 205 for SCS.

FIG. 2 illustrates the case in which the SCS configuration value 204 is μ=0 and the case in which the SCS configuration value 205 is μ=1. The subframe 201 may include one slot 202 in the case of μ=0 204, and 1 subframe 201 may include 2 slots 203 in the case of μ=1 205. That is, the number (Nₛₗₒₜ^{subframe,μ}) of slots per subframe may vary depending on the configuration value (μ) for SCS, and accordingly, the number (Nₛₗₒₜ^{frame,μ}) of slots per frame may vary. The number Nₛₗₒₜ^{subframe,μ}) and the number (Nₛₗₒₜ^{frame,μ}) according to the SCS configuration value μ may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In a 5G wireless communication system, an SSB (which may be interchangeable with an SSB (or an SS block), an SS/physical broadcast channel (PBCH) block, etc.) may be transmitted for initial access of a UE, and the SSB may include a primary SS (PSS), a secondary SS (SSS), and a PBCH.

In the initial access phase in which the UE accesses the system, the UE first may acquire DL time and frequency domain synchronization from an SS through cell search and acquire a cell identifier (ID). The SS includes a PSS and an SSS. In addition, the UE receives the PBCH for transmitting a master information block (MIB) from the BS, and acquires system information related to transmission and reception, such as system bandwidth or relevant control information, and a basic parameter value. Based on this information, the UE may perform decoding on a physical DL control channel (PDCCH) and a physical DL shared channel (PDSCH) to acquire a system information block (SIB). Thereafter, the UE exchanges UE-related identification information with the BS through a random access procedure, and initially accesses the network through procedures such as registration and authentication. Additionally, the UE may receive an SIB transmitted by the BS to obtain cell common transmission/reception related control information. The cell common transmission/reception related control information may include random access related control information, paging related control information, common control information for various physical channels, etc.

An SS is an RS for the cell search, and a SCS appropriate for a channel environment such as phase noise and the like may be applied per frequency band. In case of a data channel or control channel, a different SCS may be applied based on a service type to support various services as described above.

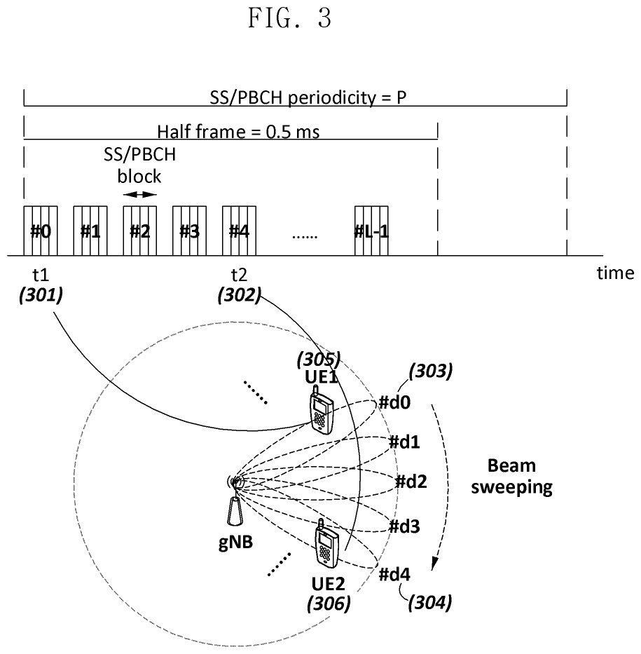

FIG. 3 illustrates a time region mapping structure of an SS and an example of a beam-sweeping operation, according to an embodiment.

For the sake of explanation, the following elements may be defined:
PSS: a signal that serves as a reference for DL time/frequency synchronization and provides some of cell ID information.
SSS: A signal that serves as a reference for DL time/frequency synchronization, and provides remaining part of cell ID information. Additionally, the SSS may serve as an RS for demodulation of the PBCH.
PBCH: A channel that provides an MIB, which is system information for transmission or reception of a data channel and a control channel of a UE. The system information may include search space related control information indicating radio resource mapping information of a control channel, scheduling control information for a separate data channel for transmission of system information, information such as system frame number (SFN), which is a frame unit index serving as a timing reference, etc.
SS/PBCH block or SSB: An SS/PBCH block includes N OFDM symbols and consists of a combination of a PSS, an SSS, and a PBCH. In case of a system to which beam sweeping technology is applied, the SS/PBCH block is the minimum unit to which beam sweeping is applied. In the 5G system, N may be 4. The BS may transmit up to L SS/PBCH blocks, and the L SS/PBCH blocks are mapped within a half frame (0.5 ms). In addition, the L SS/PBCH blocks are periodically repeated in units of a predetermined periodicity P. The periodicity P may be notified by the BS to the UE through signaling. In case where there is no separate signaling for the periodicity P, the UE applies a predetermined default value.

Referring to FIG. 3, beam sweeping may be applied in units of SS/PBCH blocks according to the passage of time. For example, a UE1 305 receives the SS/PBCH block using a beam emitted in a direction #d0 303 by beamforming applied to a SS/PBCH block #0 at time t1 301. In addition, a UE2 306 receives the SS/PBCH block using a beam emitted in a direction #d4 304 by beamforming applied to a SS/PBCH block #4 at time t2 302. The UEs may obtain, from the BS, an optimal SS through a beam, which is emitted in a direction in which the UE is located. For example, it may be difficult for the UE 1 305 to obtain time/frequency synchronization and system information from the SS/PBCH block through a beam emitted in a direction #d4 away from the position of the UE 1 305.

In addition to the initial access procedure, a UE may receive an SS/PBCH block in order to determine whether radio link quality of the current cell is maintained at a predetermined level or more. In addition, in a procedure in which a UE performs handover from a current cell to a neighboring cell, the UE may receive the SS/PBCH block of the neighboring cell in order to determine the radio link quality of the neighboring cell and obtain time/frequency synchronization of the neighboring cell.

Hereinafter, an cell initial access operation procedure of a 5G wireless communication system will be described in more detail.

The SS is a signal that serves as a reference for cell search, and may be transmitted with an application of a SCS appropriate for a channel environment (e.g., phase noise) per frequency band. A 5G BS may transmit a plurality of SSBs depending on the number of analog beams to be operated. For example, a PSS and an SSS may be mapped and transmitted over 12 RBs, and the PBCH may be mapped and transmitted over 24 RBs. Hereinafter, a structure in which the SS and the PBCH are transmitted in the 5G communication system will be described.

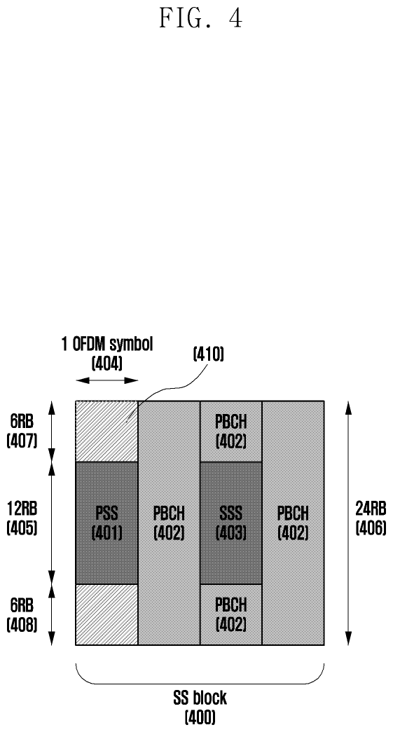

FIG. 4 illustrates an SSB for use in a wireless communication system according to an embodiment.

Referring to FIG. 4, an SSB (SS block) 400 includes a PSS 401, an SSS 403, and a PBCH 402.

The SS block 400 is mapped to four OFDM symbols 404 in the time axis. The PSS 401 and the SSS 403 may be transmitted through 12 RBs 405 in the frequency axis and through the 1st and 3rd OFDM symbols in the time axis, respectively. In the 5G system, e.g., a total of 1008 different cell IDs may be defined. The PSS 401 may have three different values and the SSS 403 may have 336 different values according to the physical layer ID of a cell (i.e., a physical cell ID (PCI)). The UE may acquire one of (336×3=) 1008 cell IDs, based on a combination of the PSS 401 and the SSS 403 through detection thereof, e.g., as expressed as Equation (1) below.

N_{ID}^{cell}=3N_{ID}⁽¹⁾+N_{ID}⁽²⁾ (1)

In Equation (1), N_{ID}⁽¹⁾ may be estimated from the SSS 403 and may have a value between 0 and 335. N_{ID}⁽²⁾ may be estimated from PSS 401 and may have a value between 0 and 2. N_{ID}^{(cell)} value, a cell ID, may be estimated by the UE from a combination of N_{ID}⁽¹⁾ and N_{ID}⁽²⁾.

The PBCH 402 may be transmitted through resources including 24 RBs 406 in the frequency axis and 6 RBs 407 and 408 at both sides except for the central 12 RBs 405, among the RBs corresponding to the 3rd OFDM symbol, in which the SSS 403 is transmitted in the 2nd to 4th OFDM symbols of the SS block in the time axis. The PBCH 402 may include a PBCH payload and a PBCH DMRS, and various system information (e.g., an MIB) may be transmitted in the PBCH payload. For example, the MIB may include information as shown in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, |
| | scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, |

notAllowed},

| | |
|---|---|
| spare | BIT STRING (SIZE (1)) |
| } | |

With reference to Table 2, the information below is explained in detail.
SSB information: The offset in the frequency domain of the SSB may be indicated through ssb-SubcarrierOffset of 4 bits in the MIB. The index of the SSB including the PBCH may be indirectly acquired through decoding of the PBCH DMRS and PBCH. In a frequency band less than 6 GHz, 3 bits acquired through decoding of the PBCH DMRS may indicate the SSB index, and in the frequency band of 6 GHz or higher, a total of 6 bits including 3 bits acquired through decoding of the PBCH DMRS and 3 bits included in PBCH payload and acquired through PBCH decoding may indicate the SSB index including PBCH.
PDCCH configuration information: A SCS of a common DL control channel is indicated through 1 bit (subCarrierSpacingCommon) in the MIB, and time-frequency resource configuration information of control resource set (CORESET) and a search space may be indicated through 8 bits (pdcch-ConfigSIB1).
SFN: 6 bits (systemFrameNumber) in the MIB are used to indicate a part of the SFN. The least significant bit (LSB) 4 bits of the SFN are included in the PBCH payload to be indirectly acquired by a UE through PBCH decoding.
Timing information in a radio frame: The UE may indirectly identify whether the SSB is transmitted in the 1st or 2nd half frame of the radio frame through 1 bit (half frame) included in the above-described SSB index and PBCH payload and acquired through PBCH decoding.

12 RBs 405 corresponding to a transmission bandwidth of the PSS 401 and the SSS 403 and 24 RBs 406 corresponding to a transmission bandwidth of the PBCH 402 are different from each other, so that in an 1st OFDM symbol in which the PSS 401 is transmitted within the transmission bandwidth of the PBCH 402, 6 RBs 407 and 6 RBs 408 exist at both sides except for the central 12 RBs in which the PSS 401 is transmitted, and the 6 RBs 407 and the 6 RBs 408 may be used for transmission of another signal or may be empty.

The SSBs may be transmitted using the same analog beam. For example, the PSS 401, the SSS 403, and the PBCH 402 may all be transmitted through the same beam. The analog beam is not applicable differently in the frequency axis such that the same analog beam is applied in all frequency axes RB in a particular OFDM symbol to which a particular analog beam is applied. For example, four OFDM symbols in which the PSS 401, the SSS 403, and the PBCH 402 are transmitted may be transmitted through the same analog beam.

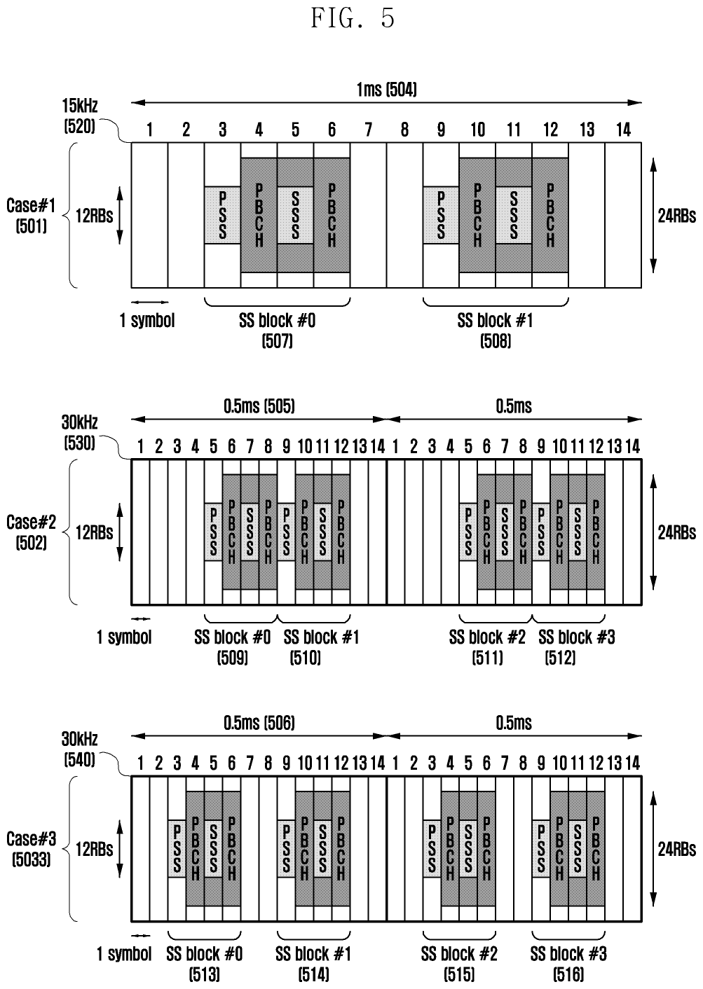

FIG. 5 illustrates an SSB in a wireless communication system being transmitted in a frequency band less than 6 GHz according to an embodiment.

Referring to FIG. 5, in a 5G communication system, a 15 kHz SCS 520 and 30 kHz SCSs 530 and 540 may be used for SSB transmission in the frequency band of 6 GHz or less. In case of the 15 kHz SCS 520, one transmission case (case #1 501) of the SSB may exist, and in case of the 30 kHz SCSs 530, 540, two transmission cases (case #2 502 and case #3 503) of the SSB may exist.

In FIG. 5, in case #1 501 of the 15 kHz SCS 520, a maximum of two SSBs may be transmitted within 1 ms 504 (or corresponding to a length of one slot in case that one slot includes 14 OFDM symbols). The example of FIG. 5 includes an SSB #0 507 and an SSB #1 508. For example, the SSB #0 507 may be mapped to four consecutive symbols starting from a 3rd OFDM symbol, and the SSB #1 508 may be mapped to four consecutive symbols starting from a 9th OFDM symbol.

Different analog beams may be applied to the SSB #0 507 and the SSB #1 508. In addition, the same beam may be applied to 3rd to 6th OFDM symbols to which SSB #0 507 is mapped, and the same beam may be applied to 9th to 12th OFDM symbols to which SSB #1 508 is mapped. The analog beam may be freely determined under the determination of a BS as to which beam to be used for the 7th, 8th, 13th, and 14th OFDM symbols to which no SSB is mapped.

In FIG. 5, in case #2 502 of the 30 kHz SCS 530, a maximum of two SSBs may be transmitted within 0.5 ms 505 (or corresponding to a length of one slot in case that the one slot includes 14 OFDM symbols), and accordingly, a maximum of four SSBs may be transmitted within 1 ms (or corresponding a length of two slots in case that one slot includes 14 OFDM symbols). As an example, FIG. 5 shows a case in which the SSB #0 509, the SSB #1 510, the SSB #2 511, and the SSB #3 512 are transmitted within 1 ms (i.e., two slots). The SSB #0 509 and the SSB #1 510 may be mapped from a 5th OFDM symbol and a 9th OFDM symbol of a 1st slot, respectively, and the SSB #2 511 and SSB #3 512 may be mapped from a 3rd OFDM symbol and a 7th OFDM symbol of a 2nd slot, respectively.

Different analog beams may be applied to the SSB #0 509, the SSB #1 510, the SSB #2 511, and the SSB #3 512. Further, the same analog beam may be applied to the 5th to the 8th OFDM symbols of the 1st slot through which SSB #0 509 is transmitted, the ninth to the 12th OFDM symbols of the 1st slot through which the SSB #1 510 is transmitted, the 3rd to the 6th symbols of the 2nd slot through which the SSB #2 511 is transmitted, the 7th to the 10 symbols of the 2nd slot through which SSB #3 512 is transmitted. The analog beam may be freely determined under the determination of a BS as to which beam to be used for the OFDM symbols to which no SSB is mapped.

In FIG. 5, in case #3 503 of the 30 kHz SCS 540, a maximum of two SSBs may be transmitted within 0.5 ms 506 (or corresponding to a length of one slot in case that one slot includes 14 OFDM symbols), and accordingly, a maximum of four SSBs may be transmitted within 1 ms (or corresponding to a length of two slots in case that one slot includes 14 OFDM symbols). As an example, FIG. 5 shows a case in which the SSB #0 513, the SSB #1 514, the SSB #2 515, and the SSB #3 516 are transmitted within 1 ms (i.e., two slots). The SSB #0 513 and the SSB #1 514 may be mapped from the 3rd OFDM symbol and the 9th OFDM symbol of the 1st slot, respectively, and the SSB #2 515 and the SSB #3 516 may be mapped from the 3rd OFDM symbol and the 9th OFDM symbol of the 2nd slot, respectively.

Different analogue beam may be used to the SSB #0 513, the SSB #1 514, the SSB #2 515, and the SSB #3 516, respectively.

As described in the above examples, the same analog beam may be used in all four OFDM symbols through which each SSB is transmitted, and the analog beam may be freely determined under the determination of a BS as to which beam to be used for the OFDM symbols to which no SSB is mapped.

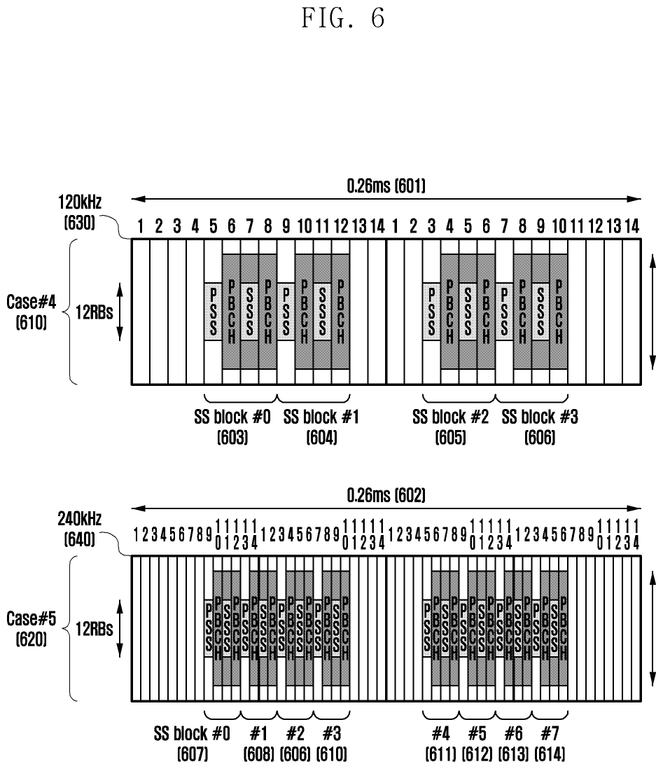

FIG. 6 illustrates an SSB in a wireless communication system being transmitted in a frequency band of 6 GHz or higher according to an embodiment.

Referring to FIG. 6, in the frequency band of 6 GHz or higher in the wireless communication system, 120 kHz SCS 630 as in the example of case #4 610 may be used for SSB transmission and 240 kHz SCS 640 as in the example of case #5 620 may be used for SSB transmission.

In case #4 610 of 120 kHz SCS 630, a maximum of four SSBs may be transmitted within 0.25 ms 601 (or corresponding to a length of two slots in case that one slot includes 14 OFDM symbols). In an example of FIG. 6, it shows a case in which the SSB #0 603, the SSB #1 604, the SSB #2 605, and the SSB #3 606 are transmitted within 0.25 ms (i.e., two slots). The SSB #0 603 may be mapped to four consecutive symbols starting from the 5th OFDM symbol of the 1st slot and the SSB #1 604 may be mapped to four consecutive symbols starting from the 9th OFDM symbol of the 1st slot. In addition, the SSB #2 605 may be mapped to four consecutive symbols starting from the 3rd OFDM symbol of the 2nd slot and the SSB #3 606 may be mapped to four consecutive symbols starting from the 7th OFDM symbol of the 2nd slot.

As described above, different analog beams may be used in the SSB #0 603, the SSB #1 604, the SSB #2 605, and the SSB #3 606, respectively. In addition, the same analog beam may be used in all four OFDM symbols through which the respective SSBs are transmitted, and the analog beam may be freely determined under the determination of a BS as to which beam to be used for the OFDM symbols to which no SSB is mapped.

In case #5 620 of 240 kHz SCS 640, a maximum of eight SSBs may be transmitted within 0.25 ms 602 (or corresponding to a length of four slots in case that one slot includes 14 OFDM symbols). The example of FIG. 6 shows a case in which the SSB #0 607, the SSB #1 608, the SSB #2 609, the SSB #3 610, the SSB #4 611, the SSB #5 612, the SSB #6 613, and the SSB #7 614 are transmitted within 0.25 ms (i.e., four slots).

The SSB #0 607 may be mapped to four consecutive symbols starting from the 9th OFDM symbol of the 1st slot, the SSB #1 608 may be mapped to four consecutive symbols starting from the 13th OFDM symbol, the SSB #2 609 may be mapped to four consecutive symbols starting from the 3rd OFDM symbol of the 2nd slot, the SSB #3 610 may be mapped to four consecutive symbols starting from the 7th OFDM symbol of the 2nd slot. The SSB #4 611 may be mapped to four consecutive symbols starting from the 5th OFDM symbol of the 3rd slot, the SSB #5 612 may be mapped to four consecutive symbols starting from the 9th OFDM symbol of the 3rd slot, the SSB #6 613 may be mapped to four consecutive symbols starting from the 13th OFDM symbol of the 3rd slot. The SSB #7 614 may be mapped to four consecutive symbols from the 3rd OFDM symbol of the 4th slot.

As described above, different analog beams may be used for the SSB #0 607, the SSB #1 608, the SSB #2 609, the SSB #3 610, the SSB #4 611, the SSB #5 612, the SSB #6 613, and the SSB #7 614, respectively. In addition, the same analog beam may be used in all four OFDM symbols through which the respective SSBs are transmitted, and the analog beam may be freely determined under the determination of a BS as to which beam to be used for the OFDM symbols to which no SSB is mapped.

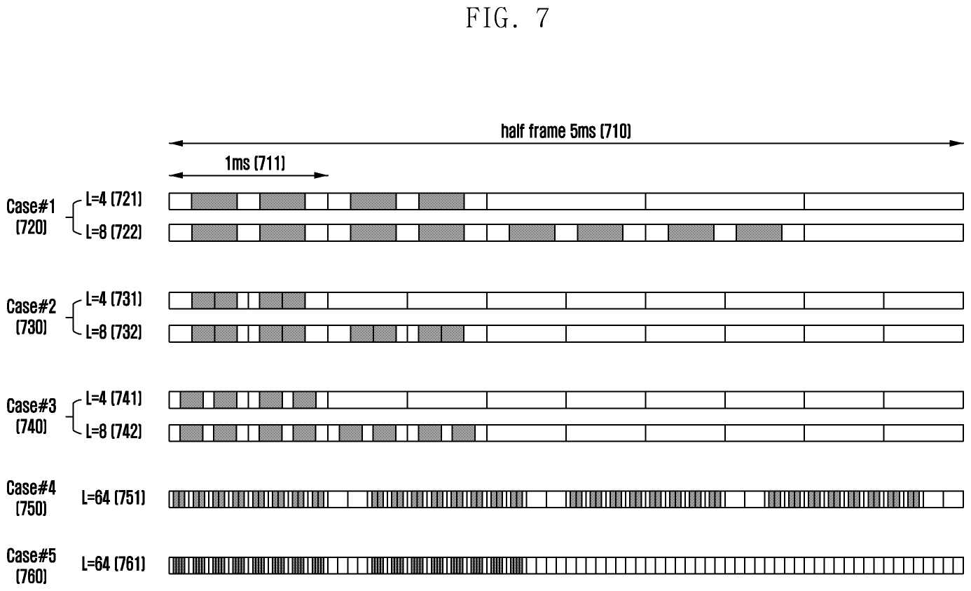

FIG. 7 illustrates an SSB according to an SCS being transmitted within 5 ms in a wireless communication system, according to an embodiment.

Referring to FIG. 7, in a 5G communication system, an SSB may be periodically transmitted, e.g., in units of time intervals 710 of 5 ms (corresponding to five subframes or half frame).

In a frequency band of 3 GHz or less, a maximum of four SSBs may be transmitted within 5 ms 710. A maximum of eight SSBs may be transmitted in a frequency band higher than 3 GHz and less than or equal to 6 GHz. A maximum of sixty four SSBs may be transmitted in the frequency band of higher than 6 GHz. As described above, the 15 kHz SCS and the 30 kHz SCS may be used at frequencies of 6 GHz or less.

In case #1 501 and 720 of the 15 kHz SCS including one slot 711 of FIGS. 5 and 7, mapping may be performed on the 1st slot and the 2nd slot in a frequency band of 3 GHz or less, and accordingly, a maximum of four SSBs 721 may be transmitted. In addition, mapping may be performed on the 1st, 2nd, 3rd, and 4th slots in a frequency band greater than 3 GHz and less than or equal to 6 GHz, and accordingly, a maximum of eight SSBs 722 may be transmitted. In case #2 502 and 730 or case #3 503 and 740 of the 30 kHz SCS including two slots of FIGS. 5 and 7, mapping may be performed starting from the 1st slot in a frequency band of 3 GHz or less, and accordingly, a maximum of four SSBs 731 and 741 may be transmitted. In addition, mapping may be performed starting from the 1st and 3rd slots in a frequency band greater than 3 GHz and less than or equal to 6 GHz, and accordingly, a maximum of eight SSBs 732 and 742 may be transmitted.

The 120 kHz SCS and the 240 kHz SCS may be used at frequencies higher than 6 GHz. In case #4 610 and 750 of the 120 kHz SCS including two slots of FIGS. 6 and 7, mapping may be performed starting from the 1st, 3rd, 5th, 7th, 11th, 13th, 15th, 17th, 21st, 23rd, 25th, 27th, 31st, 33rd, 35th, and 37th slots in a frequency band higher than 6 GHz, and accordingly, a maximum of sixty four SSBs 751 may be transmitted. In case #5 620 and 760 of the 240 kHz SCS including four slots of FIGS. 6 and 7, mapping may be performed starting from the 1st, 5th, 9th, 13th, 21st, 25th, 29th, and 33rd slots in a frequency band higher than 6 GHz, and accordingly, a maximum of sixty four SSBs 761 may be transmitted.

A UE may decode a PDCCH and a PDSCH, based on system information included in a received MIB and acquire an SIB (e.g., SIB1). The SIB may include at least one of UL cell bandwidth related information, a random access parameter, a paging parameter, a parameter related to UL power control.

In general, a UE may form a radio link with a network through a random access procedure, based on system information and synchronization with the network obtained in the cell search process of the cell. A contention-based or contention-free scheme may be used for random access. In case that the UE performs cell selection and reselection in an initial access phase of the cell, for example, contention-based random access scheme may be used for the purpose of state transition from the RRC_IDLE (radio resource control (RRC) idle) state to the RRC_CONNECTED (RRC connection) state. Contention-free random access may be used in the case of arrival of DL data, in the case of handover, or in the case of reconfiguring UL synchronization in the case of position measurement.

Table 3 the conditions (events) under which a random access procedure may be triggered in a 5G system.

TABLE 3
- Initial access from RRC_IDLE;
- RRC Connection Re-establishment procedure;
- DL or UL data arrival during RRC_CONNECTED when UL
synchronisation status is “non-synchronised”;
- UL data arrival during RRC_CONNECTED when there are no PUCCH
resources for SR available;
- SR failure;
- Request by RRC upon synchronous reconfiguration (e.g. handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a method for configuring a measurement time for radio resource management (RRM) based on an SSB (or SS block) of a 5G wireless communication system.

A UE may receive MeasObjectNR of MeasObjectToAddModList as a configuration for SSB-based intra/inter-frequency measurements and CSI-RS-based intra/inter-frequency measurements through a higher layer signaling. For example, MeasObjectNR may be configured as shown in Table 4 below.

```
TABLE 4
MeasObjectNR ::= SEQUENCE {
  ssbFrequency ARFCN-ValueNR
OPTIONAL, -- Cond SSBorAssociatedSSB
  ssbSubcarrierSpacing SubcarrierSpacing
OPTIONAL, -- Cond SSBorAssociatedSSB
  smtc1 SSB-MTC
OPTIONAL, -- Cond SSBorAssociatedSSB
  smtc2  SSB-MTC2
OPTIONAL, -- Cond IntraFreqConnected
  refFreqCSI-RS ARFCN-ValueNR
OPTIONAL, -- Cond CSI-RS
  referenceSignalConfig ReferenceSignalConfig,
  absThreshSS-BlocksConsolidation ThresholdNR
OPTIONAL, -- Need R
  absThreshCSI-RS-Consolidation ThresholdNR
OPTIONAL, -- Need R
  nrofSS-BlocksToAverage INTEGER (2..maxNrofSS-
BlocksToAverage) OPTIONAL, -- Need R
  nrofCSI-RS-ResourcesToAverage INTEGER (2..maxNrofCSI-RS-
ResourcesToAverage) OPTIONAL, -- Need R
  quantityConfigIndex INTEGER (1..maxNrofQuantityConfig),
  offsetMO Q-OffsetRangeList,
  cellsToRemoveList PCI-List
OPTIONAL, -- Need N
  cellsToAddModList CellsToAddModList
OPTIONAL, -- Need N
  blackCellsToRemoveList PCI-RangeIndexList
OPTIONAL, -- Need N
  blackCellsToAddModList SEQUENCE (SIZE (1..maxNrofPCI-
  Ranges)) OF PCI-RangeElement OPTIONAL, -- Need N
  whiteCellsToRemoveList PCI-RangeIndexList
OPTIONAL, -- Need N
  whiteCellsToAddModList SEQUENCE (SIZE (1..maxNrofPCI-
Ranges)) OF PCI-RangeElement OPTIONAL, -- Need N
  ...,
  [[
  freqBandIndicatorNR FreqBandIndicatorNR
OPTIONAL, -- Need R
  measCycleSCell ENUMERATED {sf160, sf256, sf320,
sf512, sf640, sf1024, sf1280} OPTIONAL -- Need
  ]],
  [[
  smtc3list-r16 SSB-MTC3List-r16
OPTIONAL, -- Need R
  rmtc-Config-r16 SetupRelease {RMTC-Config-r16}
OPTIONAL, -- Need M
  t312-r16 SetupRelease { T312-r16 }
OPTIONAL -- Need M
  ]]
}
```

The parameters in Table 4 are explained in more detail below.
ssbFrequency: It may configure the frequency of the SS related to MeasObjectNR.
ssbSubcarrierSpacing: It may configure the SCS of SSB. For example, FR1 may only apply 15 kHz or 30 kHz, and FR2 may only apply 120 kHz or 240 kHz.
smtc1: It may indicate SS/PBCH block measurement timing configuration (SMTC), and may configure a primary measurement timing configuration and a timing offset and duration for SSB.
smtc2: It may configure a secondary measurement timing configuration for SSB related to MeasObjectNR with PCI listed in pci-List.

In addition, the configuration may be performed through other higher layer signaling. For example, an SMTC may be configured to the UE through SIB2 for intra-frequency, inter-frequency and inter-RAT cell reselection, or reconfigurationWithSync to change NR PSCell and NR PCell. In addition, SMTC may be configured to the UE through SCellConfig to add NR SCell.

The UE may configure a first SMTC according to periodicityAndOffset (which provides periodicity and offset) through smtc1 configured through a higher layer signaling for SSB measurement. In accordance with an embodiment, the first subframe of each SMTC occasion may start from a subframe of special cell (SpCell) and an SFN that satisfies the conditions in Table 5 below.

TABLE 5

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

If smtc2 is configured, for cells indicated by the pci-List value of smtc2 in the same MeasObjectNR, the UE may configure additional SMTC according to the configured periodicity of smtc2 and the offset and duration of smtc1. In addition, the UE may be configured with smtc through smtc2-LP (with long periodicity) for the same frequency (e.g., frequencies for intra frequency cell reselection) or different frequencies (e.g., frequencies for inter frequency cell reselection), and smtc3list for IAB—mobile termination (MT), and measure the SSB. In accordance with an embodiment, the UE may not consider the SSB transmitted in a subframe other than the SMTC occasion for SSB-based RRM measurement at the configured ssbFrequency.

The BS may use various multiple transmit/receive points (TRPs) operation methods depending on serving cell configurations and PCI configurations. Among them, in case where two TRPs located at a physically distant distance have different PCIs, there may be two methods to operate the two TRPs.

### Operation Method 1

Two TRPs with different PCIs may be operated in two serving cell configurations.

Through [Operation Method 1], the BS may configure channels and signals transmitted from different TRPs by including them in different serving cell configurations. That is, each TRP has an independent serving cell configuration, and the frequency band values FrequencyInfoDLs indicated by DownlinkConfigCommon in each serving cell configuration may indicate at least some overlapping bands. Since multiple TRPs operate based on a plurality of ServCellIndexes (e.g., ServCellIndex #1 and ServCellIndex #2), each TRP may use a separate PCI. That is, the BS may allocate one PCI per ServCellIndex.

When multiple SSBs are transmitted in TRP 1 and TRP 2, the SSBs have different PCIs (e.g., PCI #1 and PCI #2). In addition, the BS may appropriately select the value of ServCellIndex indicated by the cell parameter in QCL-Info, map the PCI appropriate for each TRP, and designate the SSB transmitted in either TRP 1 or TRP 2 as the source reference RS of quasi-co-located (QCL) configuration information. However, with this configuration, since the configuration of one serving cell that may be used for carrier aggregation (CA) of the UE is applied to a plurality of TRPs, there may be a problem of limiting the freedom of CA configuration or increasing the signaling burden.

### Operation Method 2

Two TRPs with different PCIs may be operated in one serving cell configuration.

Through [Operation Method 2], the BS may configure channels and signals transmitted from different TRPs by including them in one serving cell configuration. Because the UE operates based on one ServCellIndex (e.g., ServCellIndex #1), it may be impossible to recognize the PCI (e.g., PCI #2) assigned to the second TRP. [Operation Method 2] may have more freedom in CA configuration than the above-described [Operation Method 1], but if multiple SSBs are transmitted in TRP 1 and TRP 2, the SSBs have different PCIs (e.g., PCI #1 and PCI #2), and it may be impossible for the BS to map the PCI (e.g., PCI #2) of the second TRP through ServCellIndex indicated by the cell parameter in QCL-Info. The BS may only designate the SSB transmitted in TRP 1 as the source reference RS of the QCL configuration information, and may not be able to designate the SSB transmitted in TRP 2.

As described above, [Operation Method 1] may perform a plurality of TRP operations for two TRPs with different PCIs through additional serving cell configurations without additional standard support, but [Operation Method 2] may operate based on additional UE capability report below and the configuration information of the BS.

UE capability report for [Operation Method 2] is described.

The UE may use UE capability to report to the BS that the UE may be configured with additional PCI that is different from the PCI of the serving cell through the higher layer signaling. For example, the corresponding UE capability may include parameters X1 and X2 that are independent of each other, or each of X1 and X2 may be reported as independent UE capability.

X1 refers to the maximum number of additional PCIs that may be configured to the UE, and the PCI may be different from the PCI of the serving cell. In this case, the time domain position and periodicity of the SSB corresponding to the additional PCI may be the same as those of the SSB of the serving cell.

X2 refers to the maximum number of additional PCIs that may be configured to the UE. Herein, the PCI may be different from the PCI of the serving cell. In this case, the time domain position and periodicity of the SSB corresponding to the additional PCI may be different from those of the SSB corresponding to the PCI reported as X1.

For example, by definition, the PCIs corresponding to the values reported as X1 and X2 may not be configured at the same time as each other.

For example, the values reported as X1 and X2 reported through UE capability report may each have an integer value from 0 to 7.

For example, the values reported as X1 and X2 may have different values reported in FR1 and FR2.

The higher layer signaling configuration for [Operation Method 2] is described.

The UE may be configured with the higher layer signaling, SSB-MTCAdditionalPCI−r17, from the BS based on the above-described UE capability report. The corresponding higher layer signaling may include one or more additional PCI with at least a value different from that of the serving cell, SSB transmission power corresponding to each additional PCI, and ssb-PositionInBurst corresponding to each additional PCI. The maximum number of additional PCIs that may be configured may be 7.

As an assumption for the SSB corresponding to the additional PCI with a different value from that of the serving cell, the UE may assume that the SSB has the same center frequency, SCS, and subframe number offset as the SSB of the serving cell.

The UE may assume that the reference RS (e.g. SSB or CSI-RS) corresponding to the PCI of the serving cell is always connected to an activated TCI state, and in case of the additionally configured PCI with a different value from that of the serving cell, when there is one or a plurality of PCIs, the UE may assume that only one PCI among the corresponding PCIs is connected to an activated TCI state.

When the UE has two different coresetPoolIndexs configured, the reference RS corresponding to the serving cell PCI is connected to one or a plurality of activated TCI states, and the reference RS corresponding to the additionally configured PCI with a different value from that of the serving cell is connected to one or a plurality of activated TCI states, the UE may expect that the activated TCI state(s) connected to the serving cell PCI is connected to one of the two coresetPoolIndexs and the activated TCI state(s) connected to the additional configured PCI with a different value from that of the serving cell is connected to the remaining one coresetPoolIndex.

The additional PCI with a value different from the PCI of the serving cell may be configured to the UE through the UE capability report and higher layer signaling of the BS for [Operation Method 2] described above. When the above configuration does not exist, the SSB corresponding to the addition PCI with a value different from the PCI of the serving cell that cannot be designated as the source reference RS may be used to designate the source reference RS of QCL configuration information. In addition, like the configuration information for SSB that may be configured in the higher layer signaling smtc1 and smtc2, unlike SSB that may be configured to be used for purposes such as RRM, mobility, or handover, it may be used to serve as a QCL source RS to support a plurality of TRP operations with different PCIs.

A DMRS may include a plurality of DMRS ports, and the respective ports maintain orthogonality so as not to interfere with one another by using code division multiplexing (CDM) or frequency division multiplexing (FDM). However, the term DMRS may be expressed by other terms according to a user's intention and a using purpose of an RS. The term DMRS merely suggests a specific example in order to easily explain technical features of the disclosure and to assist in understanding of the disclosure, and is not intended to limit the scope of the disclosure. That is, a person skilled in the art will understand that the term is applicable to any RS which is based on the technical concept of the disclosure.

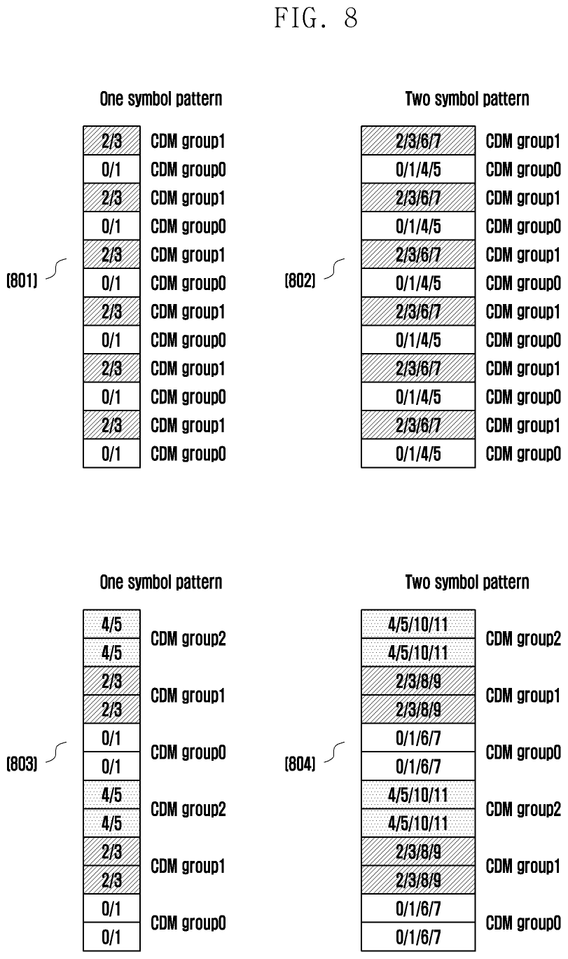

FIG. 8 illustrates a DMRS pattern (e.g., type 1 and type 2) used for communication between a BS and a terminal in a wireless communication system, according to an embodiment. Specifically, FIG. 8 illustrates two DMRS patterns that may be supported in a 5G system.

Referring to FIG. 8, reference numbers 801 and 802 correspond to DMRS type 1. Herein, reference numeral 801 indicates one symbol pattern, and reference numeral 802 indicates two symbol pattern. DMRS type 1 with reference numbers 801 and 802 is a DMRS pattern with a comb 2 structure and may be constituted with two CDM groups, and different CDM groups may undergo FDM.

In a one symbol pattern 801, CDM on a frequency may be applied to the same CDM group, thereby distinguishing between two DMRS ports, and accordingly, 4 orthogonal DMRS ports in total may be configured. One symbol pattern 801 may include DMRS port IDs mapped onto the respective CDM groups (DMRS port ID for a DL may be displayed as the illustrated numbers, +1000).

In a two symbol pattern 802, CDM on time/frequency may be applied to the same CDM group, thereby distinguishing four DMRS ports, and accordingly, 8 orthogonal DMRS ports in total may be configured. Two symbol pattern 802 may include DMRS port IDs mapped onto the respective CDM groups (DMRS port ID for a DL may be displayed as the illustrated numbers, +1000).

DMRS type 2 illustrated in reference numerals 803 and 804 is a DMRS pattern of a structure where frequency domain orthogonal cover codes (FD-OCC) are applied to adjacent subcarriers on a frequency, and may be configured with three CDM groups, and different CDM groups may undergo FDM.

In a one symbol pattern 803, CDM on a frequency may be applied to the same CDM group, thereby distinguishing between two DMRS ports, and accordingly, 6 orthogonal DMRS ports in total may be configured. One symbol pattern 803 may include DMRS port IDs mapped onto the respective CDM groups (DMRS port ID for a DL may be displayed as the illustrated numbers, +1000).

In a two symbol pattern 804, CDM on time/frequency may be applied to the same CDM group, thereby distinguishing four DMRS ports, and accordingly, 12 orthogonal DMRS ports in total may be configured. Two symbol pattern 804 may include DMRS port IDs mapped onto the respective CDM groups (DMRS port ID for a DL may be displayed as the illustrated numbers, +1000).

As described above, in an NR system, two different DMRS patterns (e.g., DMRS patterns 801 and 802 or DMRS patterns 803 and 804), and it may be configured whether each DMRS pattern is one symbol pattern 801 or 803 or the adjacent two symbol pattern 802 or 804. In addition, in the NR system, DMRS port numbers may be scheduled, and also, the number of CDM groups scheduled all together may be configured and signaled for the sake of PDSCH rate matching. In addition, in case of cyclic prefix based orthogonal frequency division multiplex (CP-OFDM), the two DMRS patterns described above may be supported in the DL and the UL, and, in case of DFT-S-OFDM, only DMRS type 1 among the above-described DMRS patterns may be supported in the UL.

In addition, an additional DMRS may be supported to be configured. A front-loaded DMRS may indicate a first DMRS that is transmitted and received in a head symbol in a time domain, and an additional DMRS may indicate a DMRS that is transmitted and received in a symbol after the front-loaded DMRS in a time domain.

In an NR system, the number of additional DMRSs may be configured to at least 0 and at most 3. In addition, in case where the additional DMRS is configured, the same pattern as the front-loaded DMRS may be assumed. In accordance with an embodiment, when information regarding whether the DMRS pattern type of the front-loaded DMRS is type 1 or type 2, information regarding whether the DMRS pattern is one symbol pattern or the adjacent two symbol pattern, and information of the number of CDM groups used along with the DMRS port are indicated, and in case where the additional DMRS is additionally configured, it may be assumed that, for the additional DMRS, the same DMRS information as the front-loaded DMRS is configured. The above-described DL DMRS configuration may be configured through RRC signaling as shown in Table 6 below

More specifically, Table 6 shows DL DMRS configuration parameters according to an embodiment.

```
TABLE 6
DMRS-UplinkConfig ::= SEQUENCE {
  dmrs-Type ENUMERATED {type2} OPTIONAL,
-- Need S
  dmrs-AdditionalPosition ENUMERATED {pos0, pos1, pos3}
OPTIONAL, -- Need S
  maxLength ENUMERATED {len2} OPTIONAL,
-- Need S
  scramblingID0 INTEGER (0..65535)
OPTIONAL, -- Need S
  scramblingID1 INTEGER (0..65535)
OPTIONAL, -- Need S
  phaseTrackingRS SetupRelease {PTRS-DownlinkConfig}
OPTIONAL, -- Need M
    ...
}
```

In Table 6, dmrs-Type may configure the DMRS type, dmrs-AdditionalPosition may configure additional DMRS OFDM symbols, maxLength may configure one symbol DMRS pattern or two symbol DMRS pattern, scramblingID1 and scramblingID1 may configure scrambling IDs, and phaseTrackingRS may configure a phase tracking RS (PTRS).

In addition, the above-described UL DMRS configuration may be configured through RRC signaling as shown in Table 7 below.

More specifically, Table 7 shows UL DMRS configuration parameters according to an embodiment.

TABLE 7

```
DMRS-UplinkConfig ::= SEQUENCE {
  dmrs-Type ENUMERATED {type2} OPTIONAL, --
Need S
  dmrs-AdditionalPosition ENUMERATED {pos0, pos1, pos3}
OPTIONAL, -- Need R
  phaseTrackingRS SetupRelease { PTRS-UplinkConfig }
OPTIONAL, -- Need M
  maxLength ENUMERATED {len2} OPTIONAL,
-- Need S
  transformPrecodingDisabled SEQUENCE {
    scramblingID0 INTEGER (0..65535)
OPTIONAL, -- Need S
    scramblingID1 INTEGER (0..65535)
OPTIONAL, -- Need S
    ...
  }
OPTIONAL, -- Need R
  transformPrecodingEnabled SEQUENCE {
    nPUSCH-Identity INTEGER (0..1007)
OPTIONAL, -- Need S
    sequenceGroupHopping ENUMERATED {disabled} OPTIONAL,
-- Need S
    sequenceHopping ENUMERATED {enabled} OPTIONAL,
-- Need S
    ...
  }
OPTIONAL, -- Need R
  ...
}
```

In Table 7, dmrs-Type may configure the DMRS type, dmrs-AdditionalPosition (which may configure the additional DMRS OFDM symbols), phaseTrackingRS may configure PTRS, maxLength may configure one symbol DMRS pattern or two symbol DMRS pattern. scramblingID0 and scramblingID1 may configure scrambling IDs, nPUSCH-Identity may configure the cell ID for DFT-s-OFDM, sequenceGroupHopping may disable sequence group hopping, and sequenceHopping may enable sequence hopping.

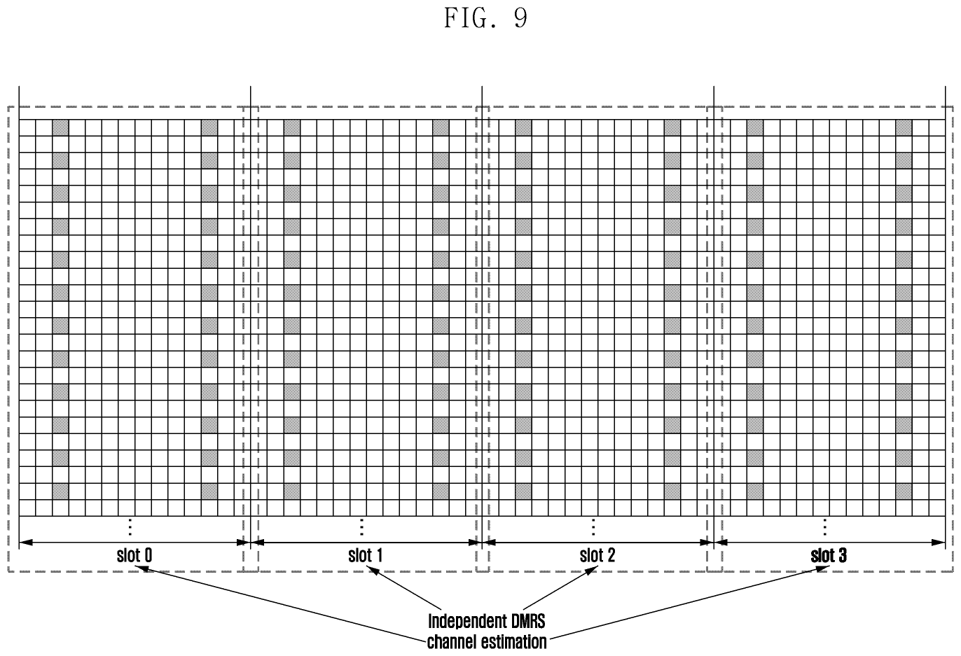

FIG. 9 illustrates channel estimation using a DMRS received through one PUSCH in a time band in a wireless communication system, according to an embodiment.

Referring to FIG. 9, in performing channel estimation for decoding data by using the DMRS, physical RBs (PRBs) bundling interlocking with a system band may be used in a frequency band and channel estimation may be performed within a precoding RB group, which is a corresponding bundling unit. In addition, channel estimation may be performed on a time basis on the assumption that only the DMRS received through one PUSCH undergoes the same precoding.

Hereinafter, a time domain resource allocation (TDRA) method for a data channel in a 5G communication system will be described. The BS may configure, to the UE via higher layer signaling (e.g., RRC signaling), a table for TDRA information on a DL data channel (e.g., a PDSCH) and a UL data channel (physical UL shared channel (PUSCH)).

The BS may configure a table including up to 17 entries (maxNrofDL-Allocations=17) for a PDSCH, and a table including up to 17 entries (maxNrofUL-Allocations=17) may be configured for the PUSCH. For example, the TDRA information may include at least one of a PDCCH-to-PDSCH slot timing (indicated as K0, and corresponding to a time interval of a slot unit between a point in time when a PDCCH is received and a point in time when a PDSCH scheduled by received PDCCH is transmitted), a PDCCH-to-PUSCH slot timing (indicated as K2, and corresponding to a time interval of a slot unit between a point in time when a PDCCH is received and a point in time when a PUSCH scheduled by received PDCCH is transmitted), information on a position and length of a start symbol in which a PDSCH or PUSCH is scheduled within a slot, and a mapping type of the PDSCH or the PUSCH.

The TDRA information for a PDSCH may be transmitted to a UE through RRC signaling, as shown in Table 8 below.

TABLE 8
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, -- |

Need S

| | |
|---|---|
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} |

OPTIONAL, -- Cond Formats1-0and1-1
}

In Table 8, k0 indicates the PDCCH-to-PDSCH timing (i.e., slot offset between DCI and its scheduled PDSCH) in slot units, mappingType indicates the mapping type of PDSCH, startSymbolAndLength indicates the start symbol and length of PDSCH, repetitionNumber may indicate the number of PDSCH transmission occasions according to a slot-based repetition method.

The TDRA information for PUSCH may be configured to the UE through RRC signaling as shown in Table 9 below.

TABLE 9
PUSCH-TimeDomainResourceAllocation information element

```
PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {
  k2 INTEGER(0 .. 32) OPTIONAL, --
Need S
  mappingType ENUMERATED {typeA, typeB},
  startSymbolAndLength INTEGER (0..127)
}
PUSCH-Allocation-r16 ::= SEQUENCE {
  mappingType-r16 ENUMERATED {typeA, typeB} OPTIONAL, --
Cond NotFormat01-02-Or-TypeA
  startSymbolAndLength-r16 INTEGER (0..127) OPTIONAL, -- Cond
NotFormat01-02-Or-TypeA
  startSymbol-r16 INTEGER (0..13) OPTIONAL, -- Cond
RepTypeB
  length-r16 INTEGER (1..14) OPTIONAL, -- Cond
RepTypeB
  numberOfRepetitions-r16 ENUMERATED {n1, n2, n3, n4, n7, n8, n12, n16}
OPTIONAL, -- Cond Format01-02
  ...
}
```

In Table 9, k2 indicates the PDCCH-to-PUSCH timing (i.e., slot offset between DCI and its scheduled PUSCH) in slot units, mappingType indicates the mapping type of PUSCH, startSymbolAndLength or StartSymbol and length indicate the start symbol and length of PUSCH, and numberOfRepetitions may indicate the number of repetitions applied to PUSCH transmission.

The BS may indicate at least one entry in the table for the TDRA information to the UE through L1 signaling (e.g., DL control information (DCI)) (e.g., it may be indicated as a ‘time domain resource allocation’ field in a DCI). The UE may obtain the TDRA information for PDSCH or PUSCH based on the DCI received from the BS.

Hereinafter, transmission of a UL data channel (e.g., a PUSCH) in the 5G system will be described. The PUSCH transmission may be dynamically scheduled by a UL grant in DCI (e.g., it is referred to as a dynamic grant (DG)-PUSCH), or may be scheduled by configured grant Type 1 or configured grant Type 2 (e.g., it is referred to as a configured grant (CG)-PUSCH). The dynamic scheduling for PUSCH transmission may be indicated by, for example, DCI format 0_0 or 0_1.

The configured grant type 1 PUSCH transmission does not receive UL grant in DCI, but may be semi-statically configured through reception of configuredGrantConfig including the rrc-ConfiguredUplinkGrant of Table 10 through higher layer signaling. The configured grant Type 2 PUSCH transmission may be semi-persistently scheduled by the UL grant in DCI after reception of the configuredGrantConfig that does not include the rrc-ConfiguredUplinkGrant of Table 10 through higher layer signaling.

When PUSCH transmission is scheduled by a configured grant, parameters applied to PUSCH transmission may be configured through ConfiguredGrantConfig, which is higher layer signaling of Table 10, except for the specific parameters provided as pusch-Config of Table 11 (e.g., dataScramblingIdentityPUSCH, txConfig, codebookSubset, maxRank, or scaling of UCI-OnPUSCH), which is higher layer signaling. For example, when the UE receives a transformPrecoder in configuredGrantConfig, which is the higher layer signaling of Table 10, the UE may apply tp-pi2BPSK in pusch-Config of <Table 11> to PUSCH transmission operating by the configured grant.

TABLE 10
ConfiguredGrantConfig

```
ConfiguredGrantConfig ::= SEQUENCE {
  frequency Hopping ENUMERATED {intraSlot, interSlot}
OPTIONAL, -- Need S,
  cg-DMRS-Configuration DMRS-UplinkConfig,
  mcs-Table ENUMERATED {qam256, qam64LowSE} OPTIONAL,
-- Need S
  mcs-TableTransformPrecoder ENUMERATED {qam256, qam64LowSE}
OPTIONAL, -- Need S
  uci-OnPUSCH SetupRelease { CG-UCI-OnPUSCH } OPTIONAL,
-- Need M
  resource Allocation ENUMERATED { resource AllocationType0,
resourceAllocationType1, dynamicSwitch },
  rbg-Size ENUMERATED {config2}
OPTIONAL, -- Need S
  powerControlLoopToUse ENUMERATED {n0, n1},
  p0-PUSCH-Alpha P0-PUSCH-AlphaSetId,
  transformPrecoder ENUMERATED {enabled, disabled}
OPTIONAL, -- Need S
  nrofHARQ-Processes INTEGER(1..17),
  repK ENUMERATED {n1, n2, n4, n8},
  repK-RV ENUMERATED {s1-0231, s2-0303, s3-0000}
OPTIONAL, -- Need R
  periodicity ENUMERATED {
  sym2, sym7, sym1x14, sym2x14, sym4x14, sym5x14, sym8x14, sym10x14, sym17x14,
sym20x14,
  sym32x14, sym40x14, sym64x14, sym80x14, sym128x14, sym170x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12,
sym20x12, sym32x12,
  sym40x12, sym64x12, sym80x12, sym128x12, sym170x12, sym256x12, sym320x12,
sym512x12, sym640x12,
  sym1280x12, sym2560x12
  },
  configuredGrantTimer INTEGER (1..64)
OPTIONAL, -- Need R
  rrc-ConfiguredUplinkGrant SEQUENCE {
    timeDomainOffset INTEGER (0..5119),
    timeDomainAllocation INTEGER (0..16),
    frequencyDomainAllocation BIT STRING (SIZE(18)),
    antennaPort INTEGER (0..31),
    dmrs-SeqInitialization INTEGER (0..1)
OPTIONAL, -- Need R
    precodingAndNumberOfLayers INTEGER (0..63),
    srs-ResourceIndicator INTEGER (0..16)
OPTIONAL, -- Need R
    mcsAndTBS INTEGER (0..31),
    frequencyHoppingOffset INTEGER (1..
maxNrofPhysicalResourceBlocks-1) OPTIONAL, -- Need R
    pathlossReferenceIndex INTEGER (0..maxNrofPUSCH-
PathlossReferenceRSs-1),
    ...
  }
OPTIONAL, -- Need R
  ...
}
```

Next, a PUSCH transmission method will be described.

A DMRS antenna port for PUSCH transmission may be the same as an antenna port for sounding reference signal (SRS) transmission. PUSCH transmission may follow a codebook-based transmission method and a non-codebook-based transmission method, respectively, according to whether a value of txConfig in pusch-Config of Table 11, which is higher signaling, is a ‘codebook’ or a ‘nonCodebook’. As described above, PUSCH transmission may be scheduled dynamically through DCI format 0_0 or 0_1, and may be configured semi-statically by a configured grant.

When the UE is instructed to schedule PUSCH transmission through the DCI format 0_0, the UE may perform a beam configuration for PUSCH transmission using the pucch-spatialRelationInfoID corresponding to the UE-specific PUCCH resource having a minimum ID (lowest ID) in the UL BWP activated in the serving cell. In accordance with an embodiment, PUSCH transmission may be performed based on a single antenna port. The UE may not expect scheduling of PUSCH transmission through the DCI format 0_0 within the BWP in which a PUCCH resource including the pucch-spatialRelationInfo is not configured. When the UE has been not configured to txConfig in pusch-Config of Table 11, the UE may not expect to be scheduled in the DCI format 0_1.

Table 11 shows an example of a PUSCH config information element (IE).

TABLE 11
PUSCH-Config

```
PUSCH-Config ::= SEQUENCE {
  dataScramblingIdentityPUSCH INTEGER (0..1023) OPTIONAL, --
Need S
  txConfig ENUMERATED {codebook, nonCodebook}
OPTIONAL, -- Need S
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
  pusch-PowerControl PUSCH-PowerControl
OPTIONAL, -- Need M
  frequencyHopping ENUMERATED {intraSlot, interSlot}
OPTIONAL, -- Need S
  frequencyHoppingOffsetLists SEQUENCE (SIZE (1..4)) OF INTEGER (1..
maxNrofPhysicalResourceBlocks-1) OPTIONAL, -- Need M
  resourceAllocation ENUMERATED { resourceAllocationType0,
resourceAllocationType1, dynamicSwitch},
  pusch-TimeDomainAllocationList SetupRelease { PUSCH-
TimeDomainResourceAllocationList } OPTIONAL, -- Need M
  pusch-AggregationFactor ENUMERATED { n2, n4, n8 }
OPTIONAL, -- Need S
  mcs-Table ENUMERATED {qam256, qam64LowSE} OPTIONAL,
-- Need S
  mcs-TableTransformPrecoder ENUMERATED {qam256, qam64LowSE}
OPTIONAL, -- Need S
  transformPrecoder ENUMERATED {enabled, disabled}
OPTIONAL, -- Need S
  codebookSubset ENUMERATED {fullyAndPartialAndNonCoherent,
partialAndNonCoherent,nonCoherent}
          OPTIONAL, -- Cond codebookBased
  maxRank INTEGER (1..4) OPTIONAL, --
Cond codebookBased
  rbg-Size ENUMERATED { config2}
OPTIONAL, -- Need S
  uci-OnPUSCH SetupRelease { UCI-OnPUSCH}
OPTIONAL, -- Need M
  tp-pi2BPSK ENUMERATED {enabled}
OPTIONAL, -- Need S
  ...
}
```

Next, a codebook-based PUSCH transmission will be described.

Codebook-based PUSCH transmission may be dynamically scheduled through a DCI format 0_0 or 0_1, and operate semi-statically according to a configured grant. When the codebook-based PUSCH is dynamically scheduled by the DCI format 0_1 or semi-statically configured by a configured grant, the UE may determine a precoder for PUSCH transmission based on an SRS resource indicator (SRI), a transmission precoding matrix indicator (TPMI), and a transmission rank (e.g., the number of PUSCH transport layers).

In accordance with an embodiment, the SRI may be given through a field SRS resource indicator in DCI or may be configured through srs-ResourceIndicator, which is higher signaling. When transmitting a codebook-based PUSCH, the UE may be configured to at least one SRS resource, and up to two SRS resources, for example. When the UE is provided with an SRI through DCI, the SRS resource indicated by the corresponding SRI may be an SRS resource corresponding to the SRI among SRS resources transmitted before the PDCCH including the corresponding SRI. Further, the TPMI and transmission rank may be given through field precoding information and number of layers in DCI or may be configured through precodingAndNumberOfLayers, which are higher signalings. The TPMI may be used for indicating a precoder applied to PUSCH transmission.

A precoder to be used for PUSCH transmission may be selected from a UL codebook having the same number of antenna ports as an nrofSRS-Ports value in SRS-Config, which is higher signaling. In codebook-based PUSCH transmission, the UE may determine a codebook subset based on the TPMI and codebookSubset in pusch-Config, which is higher signaling. The codebookSubset in the pusch-Config, which is higher signaling, may be configured to one of ‘fullyAndPartialAndNonCoherent’, ‘partialAndNonCoherent’, and ‘nonCoherent’, based on a UE capability reported by the UE to the BS.

When the UE reports ‘partialAndNonCoherent’ as the UE capability, the UE may not expect that a value of codebookSubset, which is higher signaling, is configured to ‘fullyAndPartialAndNonCoherent’. Further, when the UE reports ‘nonCoherent’ as the UE capability, the UE may not expect that a value of a codebookSubset, which is higher signaling, is configured to ‘fullyAndPartialAndNonCoherent’ or ‘partialAndNonCoherent’. When nrofSRS-Ports in the SRS-ResourceSet, which is higher signaling, indicates two SRS antenna ports, the UE may not expect that a value of the codebookSubset, which is higher signaling, is configured to ‘partialAndNonCoherent’.

The UE may be configured to one SRS resource set in which a value of usage in the SRS-ResourceSet, which is higher signaling, is configured to a ‘codebook’, and one SRS resource in the corresponding SRS resource set may be indicated through the SRI. When several SRS resources are configured in the SRS resource set in which a value of usage in the SRS-ResourceSet, which is higher signaling, is configured to a ‘codebook’, the UE may expect that a value of nrofSRS-Ports in the SRS-Resource, which is higher signaling, is configured to the same value for all SRS resources.

The UE transmits, to the BS, one or a plurality of SRS resources included in an SRS resource set in which a value of usage is configured to a ‘codebook’ according to higher signaling, and the BS selects one of SRS resources transmitted by the UE and instructs the UE to perform PUSCH transmission using transmission beam information of the corresponding SRS resource. In codebook-based PUSCH transmission, the SRI may be used as information for selecting an index of one SRS resource and may be included in DCI. Additionally, the BS may include information indicating a rank and TPMI to be used by the UE for PUSCH transmission in the DCI and transmit the same. The UE applies a precoder indicated by the TPMI and a rank indicated based on the transmission beam of the corresponding SRS resource to perform PUSCH transmission using the SRS resource indicated by the SRI.

Next, non-codebook-based PUSCH transmission will be described.

Non-codebook-based PUSCH transmission may be dynamically scheduled through a DCI format 0_0 or 0_1, or may be semi-statically configured according to a configured grant. When at least one SRS resource is configured in the SRS resource set in which a value of usage in the SRS-ResourceSet, which is higher signaling, is configured to a ‘nonCodebook’, the UE may be scheduled with non-codebook based PUSCH transmission through the DCI format 0_1.

For the SRS resource set in which a value of usage in the SRS-ResourceSet, which is higher signaling, is configured to a ‘nonCodebook’, the UE may be configured to one non-zero power (NZP) CSI-RS resource associated with the SRS resource set. The UE may calculate a precoder for SRS transmission by measuring the NZP CSI-RS resource configured in association with the SRS resource set. In case where the difference between a last reception symbol of an aperiodic NZP CSI-RS resource associated to the SRS resource set and a first symbol of aperiodic SRS transmission in the UE is less than a specific symbol (e.g., 42 symbols), the UE may not expect that information on the precoder for SRS transmission is updated.

When a value of resourceType in the SRS-ResourceSet, which is higher signaling, is configured to ‘aperiodic’, the NZP CSI-RS associated to SRS-ResourceSet is indicated by the SRS request, which is a field in the DCI format 0_1 or 1_1. When the NZP CSI-RS resource associated to SRS-ResourceSet is an aperiodic NZP CSI-RS resource, and a value of a field SRS request in the DCI format 0_1 or 1_1 is not ‘00’, it may indicate that the NZP CSI-RS associated to SRS-ResourceSet exists. The DCI may not indicate cross carrier or cross BWP scheduling. Further, when a value of the SRS request indicates existence of the NZP CSI-RS, the NZP CSI-RS may be located in a slot in which the PDCCH including the SRS request field is transmitted. The TCI states configured to the scheduled subcarrier may be not configured to QCL-TypeD.

When a periodic or semi-persistent SRS resource set is configured, the NZP CSI-RS associated to the SRS resource set may be indicated through the associatedCSI-RS in the SRS-ResourceSet, which is higher signaling. For non-codebook-based transmission, the UE may not expect that spatialRelationInfo, which is higher signaling for SRS resources, and associatedCSI-RS in SRS-ResourceSet, which is higher signaling, are configured together.

When a plurality of SRS resources are configured, the UE may determine a precoder to be applied to PUSCH transmission and a transmission rank based on the SRI indicated by the BS. The SRI may be indicated through a field SRS resource indicator in DCI or may be configured through srs-ResourceIndicator, which is higher signaling. As in the above-described codebook-based PUSCH transmission, when the UE is provided with an SRI through DCI, the SRS resource indicated by the SRI may be an SRS resource corresponding to the SRI among SRS resources transmitted before the PDCCH including the corresponding SRI. The UE may use one or a plurality of SRS resources for SRS transmission, and the maximum number of SRS resources that may be simultaneously transmitted in the same symbol in one SRS resource set may be determined by a UE capability reported by the UE to the BS. SRS resources simultaneously transmitted by the UE occupy the same RB. The UE may configure one SRS port for each SRS resource. Only one SRS resource set in which a value of usage in the SRS-ResourceSet, which is higher signaling, is configured to a ‘nonCodebook’ may be configured, and up to four SRS resources for non-codebook-based PUSCH transmission may be configured.

The BS transmits one NZP-CSI-RS associated to the SRS resource set to the UE, and the UE may calculate a precoder to use when transmitting one or a plurality of SRS resources in the corresponding SRS resource set based on the measurement result upon receiving the corresponding NZP-CSI-RS. The UE applies the calculated precoder when transmitting one or a plurality of SRS resources in the SRS resource set in which usage is configured to a ‘nonCodebook’ to the BS, and the BS may select one or a plurality of SRS resources among the received one or a plurality of SRS resources. In non-codebook-based PUSCH transmission, the SRI may indicate an index capable of expressing one or a combination of a plurality of SRS resources, and the SRI may be included in the DCI. The number of SRS resources indicated by the SRI transmitted by the BS may be the number of transmission layers of the PUSCH, and the UE may transmit the PUSCH by applying a precoder applied to SRS resource transmission to each layer.

Hereinafter, repetition transmission of a UL data channel (e.g., a PUSCH) and a single TB transmission method through a plurality of slots in a 5G system will be described in detail.

A 5G system may support two types of repetition transmission methods for UL data channels (e.g., PUSCH repetition transmission type A, PUSCH repetition transmission type B), and TB processing over multi-slot (TBoMS) PUSCH, which transmits a plurality of PUSCHs across multiple slots for a single TB. In addition, the UE may be configured with either PUSCH repetition transmission type A or B through higher layer signaling. In addition, the UE may be configured to ‘numberOfSlotsTBoMS’ through a resource allocation table and transmit TBoMS.

### PUSCH Repetition Transmission Type A

As described above, the start symbol and length of a UL data channel in one slot may be determined by the TDRA method, and the BS may transmit the number of repetition transmissions to the UE via higher layer signaling (e.g., RRC signaling) or L1 signaling (e.g., DCI). The number of slots N configured to numberOfSlotsTBoMS for determining TBS is 1.

The UE may repeatedly transmit a UL data channel having the same start symbol and length as those of the UL data channel configured above, in consecutive slots based on the number of repeated transmissions received from the BS. When at least one symbol among the symbols in a slot configured for DL by the BS to the UE or in a slot for the UL data channel repetition transmission configured by the UE is configured for DL, the UE may skip UL data channel transmission in the corresponding slot. For example, the UE may not transmit the UL data channel within the number of repeated transmissions of UL data channel. On the other hand, a UE supporting Rel-17 UL data repetition transmission may determine a slot, in which UL data repetition transmission is possible, as an available slot, and count the number of transmissions at the time of UL data channel repetition transmission in a slot determined as an available slot. When the UL data channel repetition transmission in a slot determined as an available slot is skipped, the UL data channel transmission may be repeatedly performed through a slot transmittable after postpone.

Using Table 12 below, the redundancy version may be applied according to the redundancy version pattern configured for each nth PUSCH transmission occasion.

### PUSCH Repetition Transmission Type B

As described above, the start symbol and length of a UL data channel in one slot may be determined by the TDRA method, and the BS may transmit the number of repetition transmission, numberofpetitions, through higher signaling (e.g., RRC signaling) or L1 signaling (e.g., DCI) to the UE. The number of slots N configured to numberOfSlotsTBoMS for determining TBS is 1.

First, nominal repetition of the UL data channel may be determined as follows, based on the start symbol and length of the UL data channel configured above. Here, the nominal repetition may imply a resource of a symbol configured by the BS for PUSCH repetition transmission, and the UE may determine resources usable for UL in the configured nominal repetition. In this case, a slot in which the nth nominal repetition starts may be given by

$${K}_{s} + ⌊ \frac{S + n \cdot L}{{N}_{symb}^{slot}} ⌋ ,$$

and a symbol where the nominal repetition starts in the start slot may be given by mod(S+n·L,N_{symb}^{slot}). A slot in which the nth nominal repetition ends may be given by

$${K}_{s} + ⌊ \frac{S + ( n + 1 ) \cdot L - 1}{{N}_{symb}^{slot}} ⌋ ,$$

and a symbol where the nominal repetition ends in the last slot may be given by mod(S+(n+1)·L−1,N_{symb}^{slot}). Here, n=0, . . . , numberofimpetitions−1, S indicates the start symbol of the configured UL data channel, and L may indicate the symbol length of the configured UL data channel. Kₛ may indicate a slot in which PUSCH transmission starts, and N_{symb}^{slot} may indicate the number of symbols per slot.

The UE may determine an invalid symbol for PUSCH repetition transmission type B. A symbol configured for DL by tdd-UL-DL-ConfigurationCommon or tdd-UL-DL-ConfigurationDedicated may be determined as an invalid symbol for PUSCH repetition type B. Additionally, an invalid symbol may be configured based on a higher layer parameter (e.g., InvalidSymbolPattern). For example, the invalid symbol may be configured by providing a symbol level bitmap over one slot or two slots by the higher layer parameter (e.g., InvalidSymbolPattern). In accordance with an embodiment, “1” in the bitmap may indicate an invalid symbol. Additionally, the period and pattern of the bitmap may be configured through a higher layer parameter (e.g., periodicityAndPattem). If a higher layer parameter (e.g., InvalidSymbolPattern) is configured and the InvalidSymbolPatternIndicator-ForIDCIFormal0_1 or InvalidSymbolPattemIndicator-ForDCIFormat0_2 parameter indicates 1, the UE applies the invalid symbol pattern, and if the parameter indicates 0, the invalid symbol pattern may not be applied. Alternatively, if a higher layer parameter (e.g., InvalidSymbolPattern) is configured and the InvalidSymbolPattemIndicator-ForDCIFormat0_1 or InvalidSymholPatternIndicator-ForDCIFormat0_2 parameter is not configured, the UE may apply an invalid symbol pattern.

After invalid symbols are determined in each nominal repetition, the UE may consider symbols excluding the determined invalid symbols as valid symbols. If one or more valid symbols are included in each nominal repetition, the nominal repetition may include one or more actual repetitions. Here, each actual repetition may mean a symbol actually used for PUSCH repetition transmission among the symbols configured by the configured nominal repetition, and may include a continuous set of valid symbols that may be used for PUSCH repetition transmission type B within one slot. The UE may skip actual repetition transmission in case where actual repetition having one symbol is configured as valid, except for a case in which the symbol length of the UL data channel configured is L=1.

A redundancy version may be applied using Table 12 below according to a redundancy version pattern configured for each nth actual repetition.

### TB Processing Over Multiple Slots (TBoMS)

As described above, the start symbol and length of the UL data channel are determined in one slot by the TDRA method, and the BS may transmit the number of repeated transmissions to the UE through higher layer signaling (e.g., RRC signaling) or L1 signaling (e.g., DCI). TBS may be determined using an N value greater than or equal to one, the number of slots configured to numberOfSlotsTBoMS.

The UE may transmit an UL data channel with the same start symbol and length as the UL data channel configured above in consecutive slots, based on the number of slots and the number of repeated transmissions for determining the TBS received from the BS. When at least one symbol among the symbols in a slot configured for DL by the BS to the UE or in a slot for repetition transmission of a UL data channel configured to the UE is configured to a DL, the UE may skip the UL data channel transmission in the corresponding slot. For example, the UL data channel transmission may be included in the number of UL data channel repeated transmissions but may not be performed.

On the other hand, a UE supporting Rel-17 UL data repetition transmission may determine a slot, in which UL data repetition transmission is possible, as an available slot, and a slot determined as an available slot may be counted as the number of transmissions at the time of UL data channel repetition transmission. When the UL data channel repetition transmission in a slot determined as an available slot is skipped, the UL may perform the repetition transmission through a slot transmittable after postpone the corresponding transmission.

Using Table 12 below, the redundancy version may be applied according to the redundancy version pattern configured for each nth PUSCH transmission occasion.

TABLE 12

| | rv_{id} to be applied to n^{th} transmission occasion | | | |
|---|---|---|---|---|
| | (repetition Type A) or TB processing over multiple | | | |
| rv_{id} indicated | slots) or n^{th} actual repetition (repetition Type B) | | | |
| by the DCI | ((n − (n | ((n − (n | ((n − (n | ((n − (n |
| scheduling | mod N))/N) mod | mod N))/N) mod | mod N))/N) mod | mod N))/N) mod |
| the PUSCH | 4 = 0 | 4 = 0 | 4 = 0 | 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method for determining a UL available slot for single or a plurality of PUSCH transmission in a 5G system will be described.

In accordance with an embodiment, when a UE is configured to enable AvailableSlotCounting, the UE may determine available slot based on tdd-UL-DL-ConfigurationCommon, tdd-UL-DL-ConfigurationDedicated, ssb-PositionsInBurst, and TDRA information field value to transmit Type A PUSCH repetition transmission and TBoMS PUSCH transmission. That is, when at least one symbol configured as TDRA for PUSCH in a slot for PUSCH transmission overlaps with at least one symbol for purposes other than UL transmission, the corresponding slot may be determined as an unavailable slot.

Hereinafter, a method for reducing SSB density through dynamic signaling to save BS energy in a 5G system will be described.

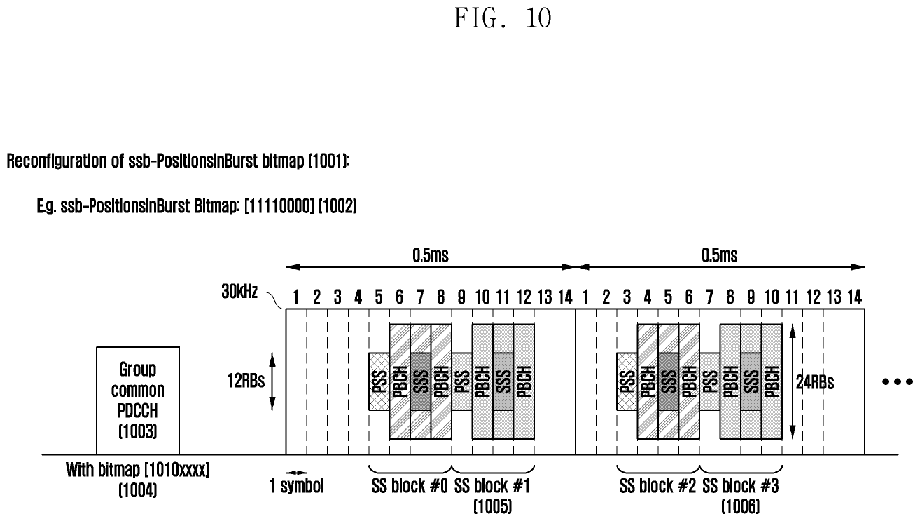

FIG. 10 illustrates a method for reconfiguring SSB transmission through dynamic signaling in a wireless communication system, according to an embodiment. Specifically, FIG. 10 provides a method 1001 for reconfiguring SSB transmission through a bitmap-based group/cell common DCI.

Referring to FIG. 10, a UE may be configured with ssb-PositionsInBurst from the BS through higher layer signaling (e.g., SIB1 or ServingCellConfigCommon). In the example of FIG. 10, the UE is configured to ssb-PositionsInBurst=‘11110000’ (1002), and up to two SSBs at a 30 kHz SCS may be transmitted within 0.5 ms (or which corresponds to a length of 1 slot in case where 1 slot includes 14 OFDM symbols). Accordingly, the UE may receive four SSB s within 1 ms time (or which corresponds to the length of 2 slots in case where 1 slot includes 14 OFDM symbols). In this case, the BS broadcasts a bitmap ‘1010xxxx’ (1004) through Group/Cell common DCI (1003) with network energy saving-radio network temporary ID (nwes-RNTI) (or es-RNTI) to reduce the density of SSB transmission to save energy, so that SSB transmission configuration information may be reconfigured. In this case, transmission of SS block #1 (1005) and SSblock #3 (1006) may be skipped based on the bitmap (1004) configured as Group/Cell common DCI. The bitmap configuration is only an example for convenience of explanation and does not limit the technical scope of the disclosure. Therefore, it may be in the form of ‘xxxx1010’, or may include a field for reconfiguring SSB transmission configuration information.

In addition, the BS may reconfigure the ssb-periodicity configured through higher layer signaling through Group/Cell common DCI. By additionally configuring timer information to indicate the timing of application of Group/Cell common DCI, SSB may be transmitted to the UE through SSB transmission information reconfigured to Group/Cell common DCI during the configured timer. Afterwards, when the timer ends, the BS may operate with SSB transmission information configured to existing higher layer signaling. This changes the configuration from a normal mode to an energy saving mode through a timer, thereby reconfiguring the SSB configuration information. As another method, the BS may configure the application timing and period of SSB configuration information reconfigured through Group/Cell common DCI to the UE using offset and duration information. In this case, the UE may not monitor the SSB for a duration from the moment the Group/Cell common DCI is received and the offset is applied.

Hereinafter, a BWP or BW adaptation method through dynamic signaling to save an energy of a BS in the 5G system will be described.

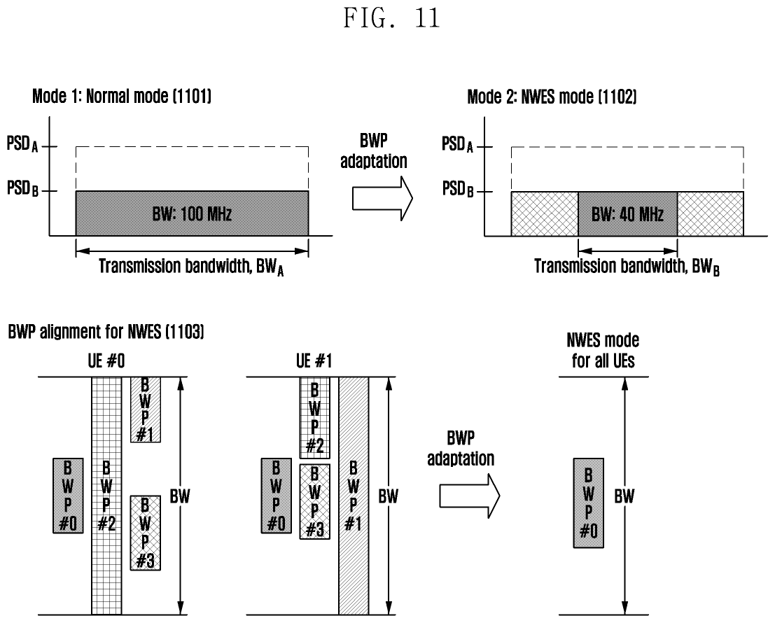

FIG. 11 illustrates a method for reconfiguring BWP and/or BW through dynamic signaling in a wireless communication system, according to an embodiment.

Referring to FIG. 11, in a normal mode, the UE may operate at BWP or BW activated through higher layer signaling and/or L1 signaling from the BS (1101). For example, the UE may operate at full BW of 100 MHz with a fixed power power spectral density (PSD_{B}). In this case, the BS may adapt BW and BWP to enable the UE to activate a narrower BW of 40 MHz while having the same power PSD_{B} for energy saving (1102). For convenience of explanation, this will be referred to as an NWES mode.

The BW or BWP adaptation operation for energy saving of the BS may be configured to equally adapt the UE-specific BWP and BW configurations through group common DCI and/or cell specific DCI (1103). For example, UE #0 and UE #1 may have different BWP constitution and positions. In order to save energy by reducing the BW used by the BS, the BW and BWP of all UEs may be configured to the same one. The BWP or BW in the operation for energy saving may be configured to one or more, which may be used to configure the BWP for each UE Group.

Hereinafter, a DRX alignment method (1201) through dynamic signaling to save an energy of a BS energy in the 5G system will be described.

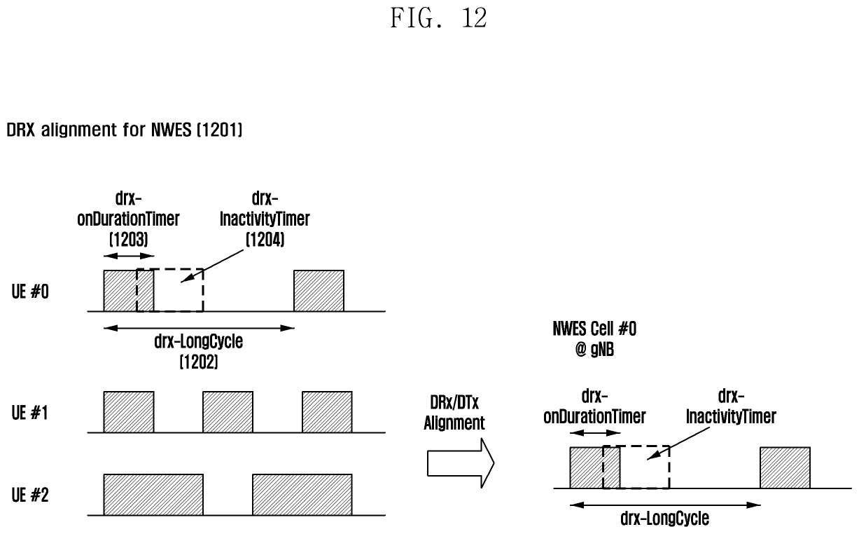

FIG. 12 illustrates a method for reconfiguring DRX through dynamic signaling in a wireless communication system, according to an embodiment.

Referring to FIG. 12, the BS may configure DRX specifically for the UE through higher layer signaling. For example, each UE may be configured to a different drx-LongCycle (1202), drx-ShortCycle, drx-onDurationTimer (1203), and drx-InactivityTimer (1204). Afterwards, the BS may configure UE-specific DRX configuration for energy saving through UE group-specific or cell-specific L1 signaling (1201). Through this, the same effect as the effect of the UE saving power through DRX can be obtained for energy saving at the BS.

Hereinafter, a method for dynamically turning on/off the antenna (i.e., TxRUs) of the BS to save an energy of the BS energy in the 5G system will be described.

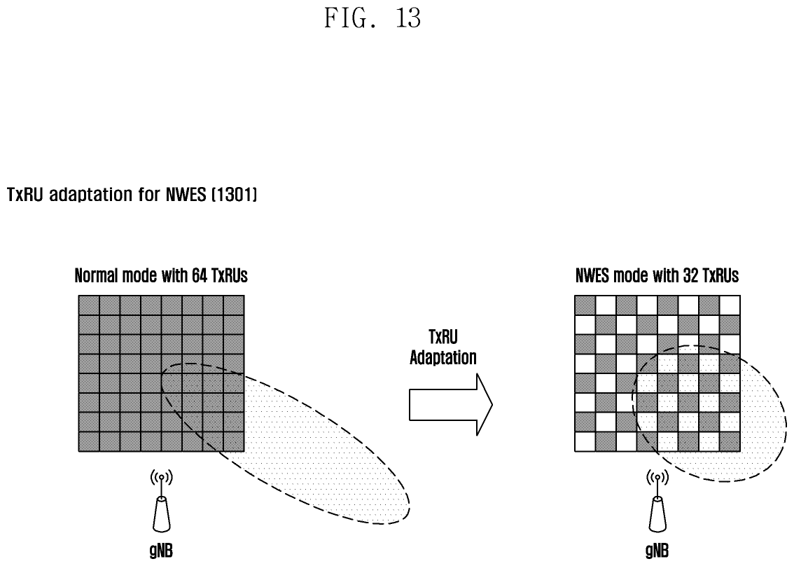

FIG. 13 illustrates an antenna adaptation method of a BS for energy saving, according to an embodiment.

Referring to FIG. 13, the BS may adapt a Tx antenna port per RU for energy saving. Since the BS's power amplifier (PA) accounts for most of the BS's energy consumption, the BS may turn off the Tx antenna to save energy (1301). For example, 64 TxRUs may be used in a normal node, while 32 TxRUs may be used in an NWES mode in case where the TxRUs are adapted for energy saving. In order to determine whether the Tx antenna may be turned off, the BS may refer to the UE's RS received power (RSRP), channel quality indicator (CQI), and RS received quality (RSRQ) to adapt the number of activated Tx antennas for each UE group or UE and transmit. The BS may configure beam information and RS information according to the antenna on/off to the UE through DCI signaling. In addition, by configuring different antenna information for each BWP, the antenna information according to BWP changes may be reconfigured.

Through the above methods (e.g., the methods illustrated in FIGS. 10 to 13), energy consumption of the BS can be reduced. In addition, the above methods may be configured simultaneously through one or more combinations. In addition, the above methods may be referred to when describing the proposed method and/or embodiment of the disclosure described later, and may correspond to modes or methods for energy saving of the BS.

Hereinafter, a timeline for BWP switching in a 5G system will be described.

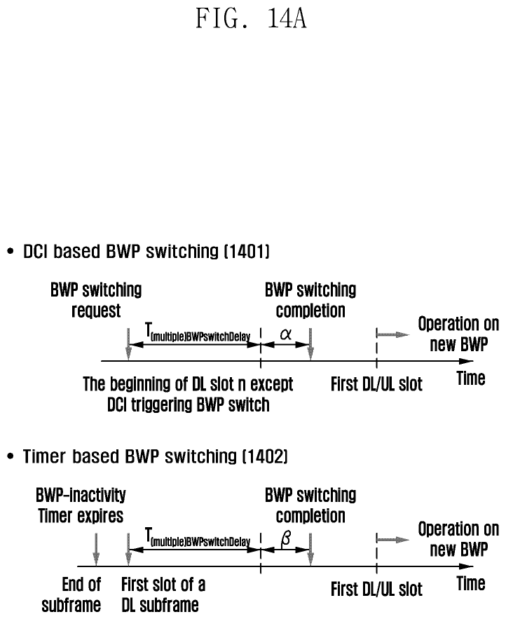

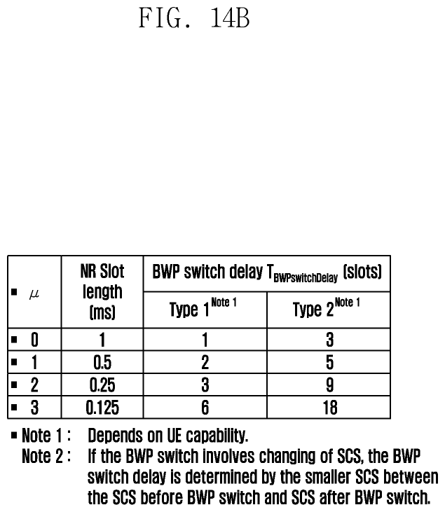

FIG. 14A illustrates a timeline according to BWP switching in a wireless communication system, according to an embodiment.

FIG. 14B illustrates an example of T_{BWPswitchDelay} value according to SCS, according to an embodiment.

The value of T_{BWPswitchDelay} or T_{(multiple)BWPswitchDelay} in FIG. 14A may be determined with reference to the BWP switch delay of FIG. 14B.

Referring to FIG. 14A, the BS may receive the T_{BWPswitchDelay} value for BWP switching from the UE through UE capability. Afterwards, the BS may configure the BWP switching of the UE based on DCI (1401). When the BS indicates BWP switching through DCI, the BWP switching timeline may be determined starting from the DL slot in which the UE received the BWP switching configuration earliest among component carriers (CCs) for which the BWP switching was indicated. The BS and the UE may calculate T_{(multiple)BWPswitchingDelay} as T_{BWPswitchDelay+D(N-1)} considering single CC or multiple CC. Here, D indicates an incremental delay due to additional CC due to multiple CC operation according to UE capability, and N indicates the number of CCs. In addition, considering the delay a according to BWP switching considering cross carrier scheduling or dormant BWP, the BS and the UE may calculate the processing time for total BWP switching as T_{(multiple)BWPswitchingDelay}+α when the BWP switching is performed based on DCI. Accordingly, the BWP switching is completed at the point where the calculated processing time for the BWP switching is applied from the start point of the previously determined DL slot, and then transmission and reception may be performed through the changed BWP starting from the first DL or UL slot.

Alternatively, when the active BWP of the BS and UE is changed based on the timer (1402), the BS and the UE may determine the BWP switching timeline starting from the first DL slot of the next subframe of the subframe where the BWP-inactivity Timer expires. The BS and the UE may determine the processing time for the BWP switching by considering simultaneous BWP switching or non-simultaneous BWP switching considering multiple CCs as the sum of T_{(multiple)BWPswitchDelay} and delay β according to the non-simultaneous timer. It is determined that BWP switching has occurred at a point after the processing time from the determined DL slot start point, and thereafter, an operation may be performed based on a new BWP from the first DL or UL slot.

Hereinafter, a timeline for beam switching in a 5G system will be described.

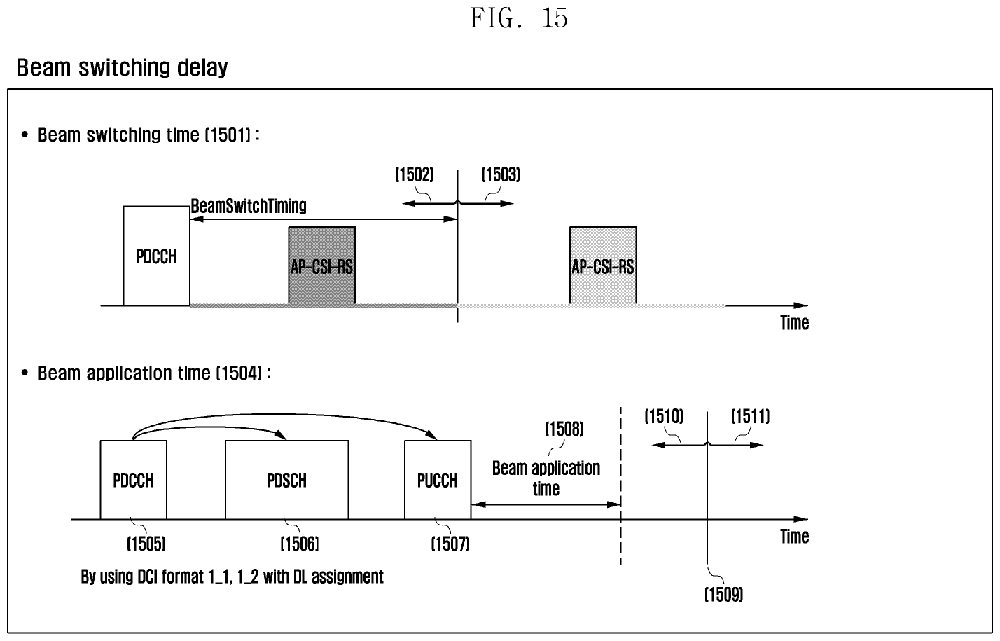

FIG. 15 illustrates a timeline for beam switching in a wireless communication system, according to an embodiment.

Referring to FIG. 15, processing times for two cases according to beam switching of the BS and the UE will be described. First, the BS may configure the beam switching of CSI-RS through DCI (1501). The processing time for beam switching is a value based on the beamSwitchingTiming reported as a capability and the SCS difference between DCI and CSI-RS and may be calculated as beamSwitchingTiming+d·2^{μ}^{_{CSIRS}}/2^{μ}^{_{PDCCH}}. Here, μ_{CSIRS} represents a SCS for CSI-RS, μ_{PDCCH} represents a SCS for PDCCH. d represents the beam switching time delay. If μ_{CSIRS}<μ_{PDDCH}, d may be determined according to Table 13; otherwise, d is 0. The BS and the UE may receive DCI for beam switching and determine that the CSI-RS has been transmitted with the changed beam after the processing time (1503). Therefore, the UE considers receiving CSI-RS through a default beam before the beam switching is performed (1502), and after the beam switching processing (1503), the UE determines that CSI-RS will be transmitted through a new beam configured to DCI.

Table 13 is an example of additional beam switching timing delay d.

TABLE 13

| | d [PDCCH |
|---|---|
| μ_{PDCCH} | symbols] |
| 0 | 8 |
| 1 | 8 |
| 2 | 14 |
| 3 | 28 |
| 5 | {56, 112} |

A beam switching operation through unified TCI will be described with another delay due to the beam switching (1504). The UE may receive DCI format 1_1 or 1_2 with DL data channel scheduling information (with DL assignment) or without DL data channel scheduling information (without DL assignment), and may apply one joint TCI state or a set of separate TCI states indicated by the TCI state field within the corresponding DCI to the UL transmission and DL reception beam.

As illustrated in FIG. 15, in case of DCI format 1_1 or 1_2 with DL assignment, in case where the UE receives DCI format 1_1 or 1_2 including DL data channel scheduling information from the BS (1505), and indicates one joint TCI state based on the integrated TCI scheme or separate TCI state set, the UE may receive a PDSCH scheduled based on the received DCI (1506), and transmit a PUCCH including HARQ-ACK, which means the successful reception of the DCI and PDSCH (1507). HARQ-ACK may indicate successful reception of both DCI and a PDSCH. When at least one of DCI and a PDSCH is not received, the UE may transmit NACK, and when reception of both DCI and the PDSCH is successful, the UE may transmit ACK. For DCI format 1_1 or 1_2 with DL assignment, if a new TCI state indicated through DCI (1505) is the same as the TCI state that has been already indicated and applied to the UL transmission and DL reception beam, the UE may maintain the previously applied TCI state. If the new TCI state is different from the previously indicated TCI state, the UE may determine that the application time of the joint TCI state or separate TCI state set that can be indicated from the TCI state field included in the DCI is applied from the start of the first slot (1509) after a period of time equal to beam application time (BAT) (1508) after PUCCH transmission (section of 1511), and may use the previously indicated TCI-state until the section (1510) before the start of the corresponding slot (1509). For DCI format 1_1 or 1_2 with DL assignment, the BAT may be configured to a certain number of OFDM symbols through higher layer signaling based on UE capability report information, and the numerology for BAT and the first slot after the BAT may be determined based on the smallest numerology of all cells to which the joint TCI state or separate TCI state set indicated through DCI is applied.

In accordance with the embodiments, when the above methods for reducing the energy consumption of the BS are configured through higher layer signaling and dynamic L1 signaling, a timeline for applying the method for saving an energy of the BS is provided, and a processing time for applying the methods is provided. Through this, the BS may perform an energy saving operation to minimize the BS's energy consumption. A method of the disclosure may also be applied to other methods (e.g., handover through dynamic L1 signaling, transmission power adaption, etc.) that can be considered in addition to the methods for energy saving of the BS.

In the disclosure, energy saving of a BS can be expressed as NWES, and energy saving and NWES can be used interchangeably.

The BS may simultaneously apply one or more energy saving methods to the UE through higher layer signaling and/or L1 signaling, and the indications may be configured in UE group specifically or cell specifically.

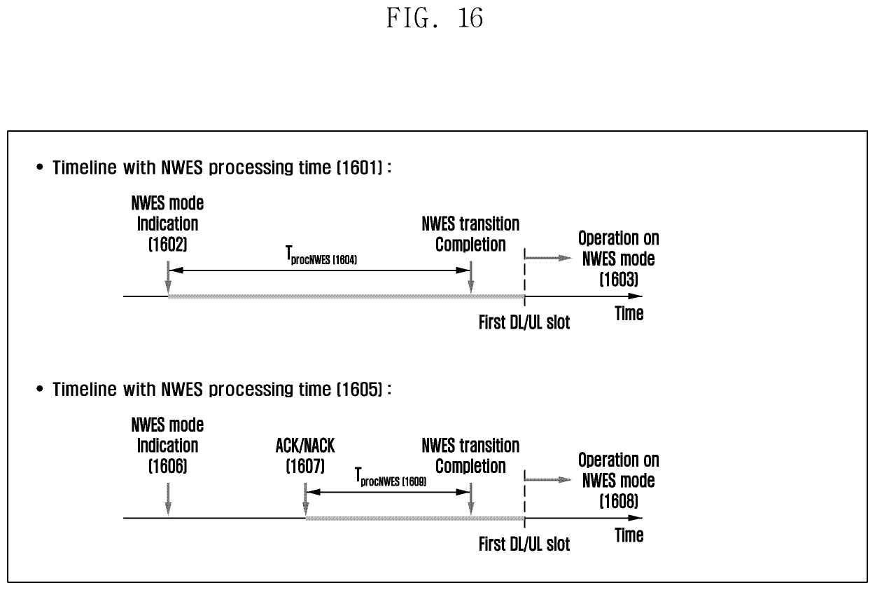

FIG. 16 illustrates a timeline for applying a method for saving an energy of a BS in a wireless communication system, according to an embodiment.

Referring FIG. 16, in 1601 in, the BS may configure a mode or methods for energy saving of the BS to the UE through higher layer signaling and/or L1 signaling (1602). The methods for energy saving may include the above RS adaptation (e.g., SSB density adaption), DRX alignment, BWP adaptation, TxRUs adaptation, etc. Thereafter, the UE may refer to the energy saving configuration information configured by the BS and calculate the processing time for applying the energy saving method using one or a combination of the following methods.

### Method 1-1

[Method 1-1] provides a method for determining a processing time when the BS applies only one energy saving method.

The BS may receive BWP switching delay, beam switching delay, and/or BAT, etc., from the UE through UE capability. Thereafter, the BS and/or the UE may refer to the UE capability and select the processing time T_{proc,NWES} according to the energy saving method as follows.

Single adaptation: T_{proc,NWES}=choice(beamSwitchTiming−r18,beam application time−r18,(multiple)BWPswitchingDelay−r18,NWES specific processing time−r18, . . . )

The beamSwitchTiming−r18 may indicate the processing time for beam switching, beam application time−r18 may indicate the processing time required to change an activated TCI, (multiple)BWPswitchingDelay−r18 may indicate the processing time for BWP switching, and NWES specific processing time−r18 may indicate a newly defined processing time for energy saving from the BS.

The “Choice” function indicates a function that selects one of several factors/elements. A value corresponding to the energy saving mode/method of the BS may be selected. For example, when the BS configures the beam switching for energy saving to the UE, beamSwitchTiming−r18 among the above values may be determined as T_{proc,NWES}.

The BS may consider the capabilities of the UEs and configure the beamSwitchTiming−r18 (e.g., symbol: 14, 28, 48, 336), beam application time−r18 (e.g., symbol: 1, 2, 4, 7, 14, 28, 42, 56, 70, 84, 98, 112, 224, 336), (multiple)BWPswitchingDelay−r18 (e.g., slot: 1, 2, 3, 5, 6, 9, 18), NWES specific processing time−r18 values to each UE group or all UEs through higher layer signaling and/or L1 signaling.

Alternatively, when the signaling to configure the BS energy saving is received, the UE may apply max beamSwitchTiming (e.g. 48 or 336), max BAT (e.g. 28 or 336), max (multiple)BWPswitchingDelay (e.g. 6 or 18), max NWES specific processing time values to the beamSwitchTiming−r18, beam application time−r18, (multiple)BWPswitchingDelay−r18, and NWES specific processing time−r18 values, respectively.

### Method 1-2

[Method 1-2] provides a method for determining a processing time when the BS simultaneously applies a plurality of energy saving methods.

The BS may receive BWP switching delay, beam switching delay, and/or BAT, etc., from the UE through UE capability. Thereafter, the BS and/or the UE may refer to the UE capability and determine the processing time T_{proc,NWES} according to the energy saving method as follows.

Multiple (or joint) adaptation: T_{proc,NWES}=max(beamSwitchTiming−r18,beam application time−r18,(multiple)BWPswitchingDelay−r18,NWES specific processing time−r18, . . . )

The beamSwitchTiming−r18 may indicate the processing time for beam switching, beam application time−r18 may indicate the processing time required to change an activated TCI, (multiple)BWPswitchingDelay−r18 may indicate the processing time for BWP switching, and NWES specific processing time−r18 may indicate a newly defined processing time for energy saving from the BS.

The “max” function is a function that outputs the maximum value among the configured factors/elements. The maximum value may be selected among the values corresponding to the energy saving modes/methods of the BS configured to the UE. For example, when the BS configures beam switching and BWP switching for energy saving to the UE, max (beamSwitchTiming−r18, (multiple)BWPswitchingDelay−r18) among the above values may be determined as T_{proc,NWES}.

The BS may consider the capabilities of the UEs and configure the beamSwitchTiming−r18 (e.g., symbol: 14, 28, 48, 336), beam application time−r18 (e.g., symbol: 1, 2, 4, 7, 14, 28, 42, 56, 70, 84, 98, 112, 224, 336), (multiple)BWPswitchingDelay−r18 (e.g., slot: 1, 2, 3, 5, 6, 9, 18), NWES specific processing time−r18 values to each UE group or all UEs through higher layer signaling and/or L1 signaling.

Alternatively, when the signaling to configure the BS energy saving is received, the UE may apply max beamSwitchTiming (e.g., 48 or 336), max BAT (e.g., 28 or 336), max (multiple)BWPswitchingDelay (e.g., 6 or 18), max NWES specific processing time values to the beamSwitchTiming−r18, beam application time−r18, (multiple)BWPswitchingDelay−r18, and NWES specific processing time−r18 values, respectively.

### Method 1-3

[Method 1-3] provides a method for determining a processing time when the BS simultaneously applies a plurality of energy saving methods.

The BS may receive BWP switching delay, beam switching delay, and/or BAT, etc., from the UE through UE capability. Thereafter, the BS may refer to the UE capability and configure the processing time according to the energy saving method to the UE through higher layer signaling and/or L1 signaling. Thereafter, when the UE receives the signaling for energy saving from the BS, the processing time may be determined as the NWES specific processing time−r18 configured above.

Through the above methods, the UE may determine the processing time for applying the BS energy saving method. Through this, the BS may configure the same processing time to a plurality of UEs. Thereafter, the UE may apply T_{proc,NWES} (1604) starting from the DL slot that has received the signaling for NWES from the BS, and then perform the NWES operation starting from the first DL or UL slot (1603).

The UE may not consider transmitting or receiving DL or UL during T_{proc,NWES}. Alternatively, the UE may determine transmission and reception of DL or UL during T_{proc,NWES} according to the method applied for NWES.

A timeline considering ACK/NACK for applying an energy saving method when receiving methods for energy saving (NWES) from a BS will be described below.

The BS may simultaneously configure one or a plurality of energy saving methods to the UE through higher layer signaling and/or L1 signaling, and the instruction may be configured in UE group specifically or cell specifically.

Referring to 1605 in FIG. 16, the BS may configure a mode or methods for energy saving of the BS to the UE through higher layer signaling and/or L1 signaling (1606). The methods for energy saving may include the above RS adaptation (e.g., SSB density adaption), DRX alignment, BWP adaptation, TxRUs adaptation, etc. Thereafter, the UE may transmit an ACK/NACK to the BS regarding whether or not the NWES indication is received and/or whether NWES is applicable (1607). When transmitting an ACK, the UE may refer to the energy saving configuration information configured by the BS and calculate the processing time for applying the energy saving method using one or a combination of the following methods. On the other hand, in case of transmitting a NACK, the UE may maintain its existing operation.

### Method 1-1

[Method 1-1] provides a method for determining a processing time when the BS applies only one energy saving method.

The BS may receive BWP switching delay, beam switching delay, and/or BAT, etc., from the UE through UE capability. Thereafter, the BS and/or the UE may refer to the UE capability and select the processing time T_{proc,NWES} according to the energy saving method as follows.

Single adaptation: T_{proc,NWES}=choice(beamSwitchTiming−r18,beam application time−r18,(multiple)BWPswitchingDelay−r18,NWES specific processing time−r18, . . . )

The beamSwitchTiming−r18 may indicate the processing time for beam switching, beam application time−r18 may indicate the processing time spent to change an activated TCI, (multiple)BWPswitchingDelay−r18 may indicate the processing time for BWP switching, and NWES specific processing time−r18 may indicate a newly defined processing time for energy saving from the BS.

The “Choice” function indicates a function that selects one of several factors/elements. A value corresponding to the energy saving mode/method of the BS may be selected. For example, when the BS configures the beam switching for energy saving to the UE, beamSwitchTiming−r18 among the above values may be determined as T_{proc,NWES}.

The BS may consider the capabilities of the UEs and configure the beamSwitchTiming−r18 (e.g., symbol: 14, 28, 48, 336), beam application time−r18 (e.g., symbol: 1, 2, 4, 7, 14, 28, 42, 56, 70, 84, 98, 112, 224, 336), (multiple)BWPswitchingDelay−r18 (e.g., slot: 1, 2, 3, 5, 6, 9, 18), NWES specific processing time−r18 values to each UE group or all UEs through higher layer signaling and/or L1 signaling.

Alternatively, when the signaling to configure the BS energy saving is received, the UE may apply max beamSwitchTiming (e.g., 48 or 336), max BAT (e.g., 28 or 336), max (multiple)BWPswitchingDelay (e.g., 6 or 18), max NWES specific processing time values to the beamSwitchTiming−r18, beam application time−r18, (multiple)BWPswitchingDelay−r18, and NWES specific processing time−r18 values, respectively.

### Method 1-2

[Method 1-2] provides a method for determining a processing time when the BS simultaneously applies a plurality of energy saving methods.

The BS may receive BWP switching delay, beam switching delay, and/or BAT, etc., from the UE through UE capability. Thereafter, the BS and/or the UE may refer to the UE capability and select the processing time T_{proc,NWES} according to the energy saving method as follows.

Multiple (or joint) adaptation: T_{proc,NWES}=max(beamSwitchTiming−r18,beam application time−r18,(multiple)BWPswitchingDelay−r18,NWES specific processing time−r18, . . . )

The beamSwitchTiming−r18 may indicate the processing time for beam switching, beam application time−r18 may indicate the processing time spent to change an activated TCI, (multiple)BWPswitchingDelay−r18 may indicate the processing time for BWP switching, and NWES specific processing time−r18 may indicate a newly defined processing time for energy saving from the BS.

The “max” function is a function that outputs the maximum value among the configured factors/elements. The maximum value may be selected among the values corresponding to the energy saving modes/methods of the BS configured to the UE. For example, when the BS configures beam switching and BWP switching for energy saving to the UE, max (beamSwitchTiming−r18, (multiple)BWPswitchingDelay−r18) among the above values may be determined as T_{proc,NWES}.

The BS may consider the capabilities of the UEs and configure the beamSwitchTiming−r18 (e.g., symbol: 14, 28, 48, 336), the beam application time−r18 (e.g., symbol: 1, 2, 4, 7, 14, 28, 42, 56, 70, 84, 98, 112, 224, 336), the (multiple)BWPswitchingDelay−r18 (e.g., slot: 1, 2, 3, 5, 6, 9, 18), the NWES specific processing time−r18 values to each UE group or all UEs through higher layer signaling and/or L1 signaling.

Alternatively, when the signaling to configure the BS energy saving is received, the UE may apply max beamSwitchTiming (e.g., 48 or 336), max BAT (e.g. 28 or 336), max (multiple)BWPswitchingDelay (e.g., 6 or 18), max NWES specific processing time values to the beamSwitchTiming−r18, beam application time−r18, (multiple)BWPswitchingDelay−r18, and NWES specific processing time−r18 values, respectively.

### Method 1-3

[Method 1-3] provides a method for determining a processing time when the BS simultaneously applies a plurality of energy saving methods.

The BS may receive BWP switching delay, beam switching delay, and/or BAT, etc., from the UE through UE capability. Thereafter, the BS may refer to the UE capability and configure the processing time according to the energy saving method to the UE through higher layer signaling and/or L1 signaling. Thereafter, when the UE receives the signaling for energy saving from the BS, the processing time may be determined as the NWES specific processing time−r18 configured above.

Through the above methods, the UE may determine the processing time for applying the BS energy saving method. Through this, the BS may configure the same processing time to a plurality of UEs. Thereafter, the UE may apply T_{proc,NWES} (1609) starting from the UL slot that has transmitted ACK to the BS, and then perform the NWES operation starting from the first DL or UL slot (1608).

The UE may not consider transmitting or receiving DL or UL during T_{proc,NWES}. Alternatively, the UE may determine transmission and reception of DL or UL during T_{proc,NWES} according to the method applied for NWES.

A flowchart and block diagram of a UE and BS according to reconfiguration of a RS for energy saving according to an embodiment of the disclosure will be described below.

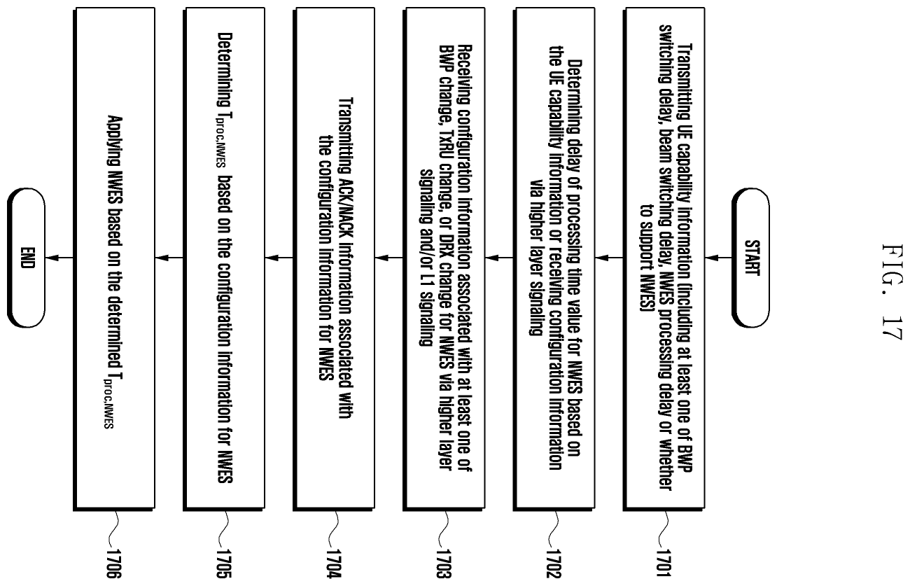

The operations in FIGS. 17 and/or 18 may be performed based on the above-described embodiments and/or methods.

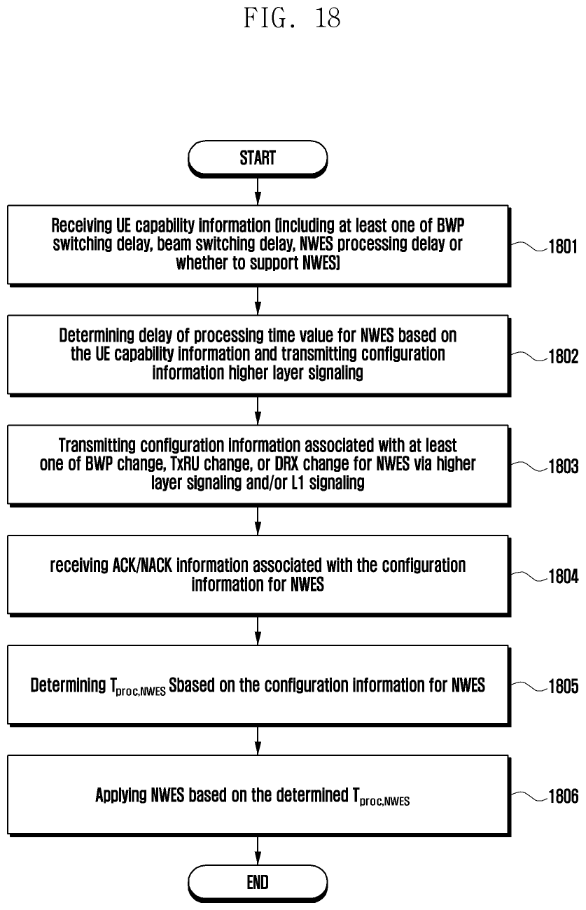

FIGS. 17 and 18 are only examples to help understand the disclosure, and the scope of the disclosure is not limited thereto. An order of operations in FIGS. 17 and 18 may be changed, or two or more operations may be combined to be performed. In addition, in some cases, some operations in FIGS. 17 and 18 may be omitted.

FIG. 17 is a flowchart illustrating an energy saving method performed by a UE in a wireless communication system, according to an embodiment.

Referring to FIG. 17, in step 1701, the UE may transmit UE capability information to the BS. The UE capability information may include BWP switching delay, beam switching delay, or NWES processing delay, and information on whether NWES is supported.

In step 1702, the UE may determine a delay or processing timing value for NWES based on the reported UE capability information, or may receive information about the delay or processing timing value for NWES through higher layer signaling from the BS.

In step 1703, the UE may receive configuration information associated with at least one of BWP change, TxRU change, and/or DRX alignment for NWES through higher layer signaling and/or L1 signaling.

In step 1704, the UE may transmit ACK/NACK information about the configuration information for the configured NWES to the BS. Alternatively, the UE may apply the method for NWES after receiving the NWES configuration indication without transmitting the ACK/NACK information.

In step 1705, the UE may determine the processing time T_{proc,NWES} according to a method for NWES configured above.

In step 1706, the UE may apply NWES from the first DL or UL slot after the T_{proc,NWES} determined from the slot in which the NWES indication/configuration information has been received.

FIG. 18 is a flowchart illustrating a BS energy saving method in a wireless communication system, according to an embodiment.

Referring to FIG. 18, in step 1801, the BS may receive UE capability information from the UE. The UE capability information may include BWP switching delay, beam switching delay, or NWES processing delay, and information on whether NWES is supported.

In step 1802, the BS may determine a delay or processing timing value for NWES based on the received UE capability information, or transmits information about the delay or processing timing value for NWES to the UE through higher layer signaling.

In step 1803, the BS may transmit configuration information associated with at least one of BWP change, TxRU change, and/or DRX alignment for NWES through higher layer signaling and/or L1 signaling.

In step 1804, the BS may receive ACK/NACK information about the configuration information for the configured NWES from the UE. Alternatively, the BS may not receive the ACK/NACK information.

In step 1805, the BS may determine T_{proc,NWES} according to a method for NWES configured above.

In step 1806, the BS may apply NWES from the first DL or UL slot after the T_{proc,NWES} determined from the slot in which the NWES indication/configuration information has been transmitted.

As described above, a method performed by a UE to reduce energy consumption of a BS in a wireless communication system according to an embodiment of the disclosure may include operations of receiving configuration information about at least one of (i) reconfiguration of RS transmission, (ii) bandwidth/BWP reconfiguration, (iii) antenna port reconfiguration, or (iv) DRX reconfiguration for energy saving of the BS through higher layer signaling or L1 signaling, determining a processing time based on the configuration information, and applying an energy saving technology of the BS reconfigured after the processing time.

A method for reducing energy consumption by a BS in a wireless communication system according to an embodiment of the disclosure may include operations of transmitting configuration information about at least one of (i) reconfiguration of RS transmission, (ii) bandwidth/BWP reconfiguration, (iii) antenna port reconfiguration, or (iv) DRX reconfiguration for energy saving of the BS through higher layer signaling or L1 signaling, and applying an energy saving technology of the BS reconfigured after the processing time. The processing time for applying the reconfiguration is determined by the UE based on the configuration information.

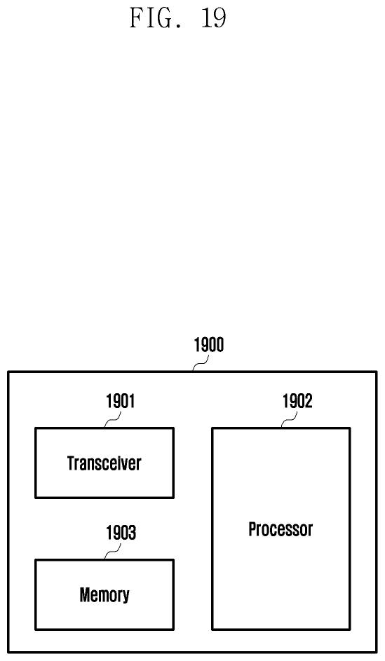

The above-described embodiments and/or methods may be performed by a UE/BS in FIGS. 19 and/or 20.

FIG. 19 illustrates a UE, according to an embodiment.

Referring to FIG. 19, a UE 1900 includes a transceiver 1901, a controller (e.g., a processor) 1902, and a storage (e.g., a memory) 1903. The transceiver 1901, controller 1902, and storage 1903 of the UE 1900 may operate according to at least one or combination of the methods corresponding to the above-described embodiments. However, the components of the UE 1900 are not limited to the illustrated example. The UE 1900 may further include additional components other than the above-described components, or may include fewer components. In addition, in a specific case, the transceiver 1901, the controller 1902, and the storage 1903 may be implemented in a single chip.

The transceiver 1901 may include a transmitter and a receiver. The transceiver 1901 may transmit and receive signals to and from the BS. The signal may include control information and data. The transceiver 1901 may include an RF transmitter that up-converts and amplifies the frequency of a transmitted signal, and an RF receiver that low-noise amplifies a received signal and down-converts the frequency. The transceiver 1901 may receive a signal through a radio channel, output the signal to the controller 1902, and transmit the signal output from the controller 1902 through a radio channel.

The controller 1902 may control a series of processes in which the UE 1900 may operate according to the above described embodiment of the disclosure. For example, the controller 1902 may perform or control the operation of the UE for performing at least one or combination of the methods according to the embodiments of the disclosure. The controller 1902 may include at least one processor. For example, the controller 1902 may include a communication processor (CP) for performing control for communication, and an application processor (AP) for controlling a higher layer (e.g., an application).

The storage 1903 may store data or control information (e.g., information related to channel estimates using DMRS transmitted from the PUSCH contained in a signal obtained from the UE 1900), and may include an area for storing data required for the control by the controller 1902 and data generated during the control by the controller 1902.

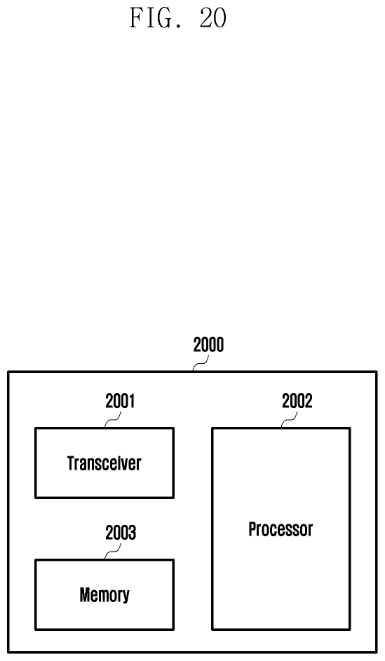

FIG. 20 illustrates a BS, according to an embodiment.

Referring to FIG. 20, the BS 2000 includes a transceiver 2001, a controller (e.g., a processor) 2002, and a storage (e.g., a memory) 2003. The transceiver 2001, the controller 2002, and the storage 2003 of the BS 2000 may operate according to at least one or combination of the methods corresponding to the above described embodiments. However, the components of the BS 2000 are not limited to the illustrated example. The BS 2000 may further include additional components other than the above-described components, or may include fewer components. In addition, in a specific case, the transceiver 2001, the controller 2002, and the storage 2003 may be implemented in the form of a single chip.

The transceiver 2001 may include a transmitter and a receiver according to an embodiment. The transceiver 2001 may transmit and receive signals to and from the UE. The signal may include control information and data. The transceiver 2001 may include an RF transmitter that up-converts and amplifies the frequency of a transmitted signal, and an RF receiver that low-noise amplifies and down-converts a received signal. The transceiver 2001 may receive a signal through a radio channel to output the received signal to the controller 2002 and transmit the signal output from the controller 2002 through a radio channel.

The controller 2002 may control a series of processes in which the BS 2000 may operate, according to the above described embodiment of the disclosure. For example, the controller 2002 may perform or control the operation of the BS for performing at least one or combination of the methods according to the embodiments of the disclosure. The controller 2002 may include at least one processor. For example, the controller 2002 may include a CP for performing control for communication, and an AP for controlling a higher layer (e.g., an application).

The storage 2003 may store data or control information (e.g., information related to channel estimates using DMRS transmitted from the PUSCH determined by the BS 2000) or data or control information received from the UE, and may include an area for storing data required for the control by the controller 2002 and data generated during the control by the controller 2002.

According to the above-described embodiments of the disclosure, by defining a signal transmission method of a BS in a wireless communication system, a problem of excessive energy consumption can be resolved and high energy efficiency can be achieved.

By defining a system bandwidth/BWP adaptation method of a BS in a wireless communication system, a problem of excessive energy consumption can be resolved and high energy efficiency can be achieved.

Further, by defining a system antenna port (i.e., TxRU or RxRU) adaptation method of a BS in a wireless communication system, a problem of excessive energy consumption can be resolved and high energy efficiency can be achieved.

Additionally, by defining a state and DTX/DRX configuration method for energy saving of a BS in a wireless communication system, a problem of excessive energy consumption can be resolved and high energy efficiency can be achieved.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station (BS), information for configuring at least one configuration associated with network energy saving, in a first slot;
identifying a delay time for applying the network energy saving; and
applying the network energy saving at a second slot that is determined based on the first slot and the delay time.

2. The method of claim 1, wherein discontinuous reception (DRX) associated with the network energy saving is configured based on the information.

3. The method of claim 1, wherein the information is received via downlink control information (DCI).

4. The method of claim 1, wherein the at least one configuration associated with the network energy saving includes at least one of a first configuration of a synchronization signal (SS)/physical broadcast channel (PBCH) block, a second configuration of a bandwidth part (BWP), a third configuration of discontinuous reception (DRX), or a fourth configuration of antennas.

5. The method of claim 1, wherein in case that a plurality of configurations is configured based on the information, the delay time is identified based on a maximum value of processing times associated with the plurality of configurations.

6. The method of claim 1, further comprising transmitting, to the BS, capability information including information associated with the delay time.

7. The method of claim 1, further comprising transmitting, to the BS, feedback information as a response to receiving the information,
wherein the second slot is determined further based on a slot in which the feedback information is transmitted.

8. A terminal in a wireless communication system, the terminal comprising:
a transceiver; and
a processor configured to:
receive, via the transceiver, from a base station (BS), information for configuring at least one configuration associated with network energy saving, in a first slot,
identify a delay time for applying the network energy saving, and
apply the network energy saving at a second slot that is determined based on the first slot and the delay time.

9. The terminal of claim 8, wherein discontinuous reception (DRX) associated with the network energy saving is configured based on the information.

10. The terminal of claim 8, wherein the information is received via downlink control information (DCI), and
wherein the at least one configuration associated with the network energy saving includes at least one of a first configuration of a synchronization signal (SS)/physical broadcast channel (PBCH) block, a second configuration of a bandwidth part (BWP), a third configuration of discontinuous reception (DRX), or a fourth configuration of antennas.

11. The terminal of claim 8, wherein in case that a plurality of configurations is configured based on the information, the delay time is identified based on a maximum value of processing times associated with the plurality of configurations.

12. The terminal of claim 8, wherein the controller is further configured to transmit, via the transceiver, to the BS, capability information including information associated with the delay time.

13. The terminal of claim 8, wherein the controller is further configured to transmit, via the transceiver, to the BS, feedback information as a response to receiving the information, and
wherein the second slot is determined further based on a slot in which the feedback information is transmitted.

14. A method performed by a base station (BS) in a wireless communication system, the method comprising:
determining to apply network energy saving; and
transmitting, to a terminal, in a first slot, information for configuring at least one configuration associated with the network energy saving,
wherein the network energy saving is applied at a second slot that is determined based on the first slot and a delay time associated with the network energy saving.

15. A base station (BS) in a wireless communication system, the BS comprising:
a transceiver; and
a processor configured to:
determine to apply network energy saving, and
transmit, via the transceiver, to a terminal, in a first slot, information for configuring at least one configuration associated with the network energy saving,
wherein the network energy saving is applied at a second slot that is determined based on the first slot and a delay time associated with the network energy saving.
